(19) United States
(12) Patent Application Publication
(10) Pub. No.: US 2017/0087759 A1
(43) Pub. Date: Mar. 30, 2017

(54) System, Method and Apparatus For Producing a Multi-Layer, Annular Microcapillary Product

(71) Applicant: Dow Global Technologies LLC, Midland, MI (US)

(72) Inventors: Wenyi Huang, Midland, MI (US); Joseph Dooley, Charlestown, IN (US); Patrick Chang Dong Lee, South Burlington, VT (US); Thomas J. Parsons, Midland, MI (US); Debkumar Bhattacharjee, Blue Bell, PA (US)

(21) Appl. No.: 15/311,202

(22) PCT Filed: Apr. 28, 2015
(86) PCT No.: PCT/US15/27957

§ 371 Date: Nov. 15, 2016

Related U.S. Application Data
(60) Provisional application No. 61/993,341, filed on May 15, 2014.

(51) Int. Cl. B29C 47/26; B29C 47/06; B29C 47/92; B29C 47/00

(52) U.S. Cl. CPC B29C 47/26; B29C 47/0023; B29C 47/0026; B29C 47/0054; B29C 47/065; B29C 47/92; B29C 2947/92619; B29C 2947/92647; B29C 2947/92942; B29K 2101/12

(57) ABSTRACT

The instant disclosure provides a die assembly for producing an annular microcapillary product. The die assembly is operatively connectable to an extruder having a thermoplastic material passing therethrough. The die assembly includes a shell, an inner manifold, an outer manifold, and a die assembly. The inner and outer manifolds are positionable in the shell with matrix flow channels thereabout to receive the thermoplastic material therethrough such that matrix layers of the thermoplastic material are extrudable therefrom. The die insert is disposable between the inner and the outer manifolds, and has a distribution manifold with a tip at an end thereof defining microcapillary channels to pass a microcapillary material therethrough whereby microcapillaries are formed between the matrix layers.

### BACKGROUND

The instant disclosure relates generally to a system, method and apparatus for producing a multi-layer, annular microcapillary product.

Polymers may be formed into films for separating, holding or containing items. Such films (or sheets) may be used, for example, as plastic bags, wraps, coatings, etc.

Polymeric material, e.g. polyolefins, may be formed into polymeric films via an extruder at increased temperatures and pressures. The extruder typically has one or more screws, e.g. single screw extruder or twin screw extruder. The polymer is forced out of the extruder through a die and formed into a film. The die may have a profile (or shape) used to define the shape of the extrudate or film as it exits the die.

Despite research efforts in film forming techniques, there is still a need for producing new microcapillary containing extrudate designs having improved properties. Furthermore, there is still a need for new die designs facilitating the production of microcapillary containing extrudate having improved properties.

### SUMMARY

In at least one aspect, the disclosure relates to a die assembly for producing a multi-layer, annular microcapillary product. The die assembly is operatively connectable to an extruder having a thermoplastic material passing therethrough. The die assembly includes a shell, an inner manifold, an outer manifold, and a die insert. The inner and outer manifolds are positionable in the shell with matrix flow channels thereabout to receive the thermoplastic material therethrough such that matrix layers of the thermoplastic material are extrudable therefrom. The die insert is disposable between the inner and outer manifolds, and has a distribution manifold with a tip at an end thereof defining microcapillary channels to pass a microcapillary material therethrough whereby microcapillaries are formed between the matrix layers.

In another aspect, the disclosure relates to an extruder assembly for producing a multi-layer, annular microcapillary product. The extruder assembly includes at least one extruder, at least one microcapillary material source, and a die assembly. The extruder includes a housing having an inlet for receiving a thermoplastic material and a driver positionable in the housing to advance the thermoplastic material through the housing. The die assembly is operatively connectable to an extruder to receive the thermoplastic material therethrough. The die assembly includes a shell, an inner manifold, an outer manifold, and a die insert. The inner and outer manifolds are positionable in the shell with matrix flow channels thereabout to receive the thermoplastic material therethrough such that matrix layers of the thermoplastic material are extrudable therefrom. The die insert is disposable between the inner and outer manifolds, and has a distribution manifold with a tip at an end thereof defining microcapillary channels to pass a microcapillary material therethrough whereby microcapillaries are formed between the matrix layers.

In yet another aspect, the disclosure relates to a method for producing a multi-layer, annular microcapillary product. The method involves passing a thermoplastic material through a die assembly. The die assembly includes a shell, an outer manifold and an inner manifold positioned in the shell with matrix flow channels thereabout, and a die insert positioned between the inner and outer manifolds. The die insert includes a distribution manifold with a tip at an end thereof defining microcapillary channels to pass a microcapillary material therethrough whereby microcapillaries are formed between the matrix layers. The method also involves extruding layers of the thermoplastic material through the matrix flow channels while passing a capillary material through the microcapillary channels and between the matrix layers. A multi-layer, annular microcapillary product may be produced by the method.

Finally, in another aspect, the disclosure relates to a multi-layer, annular microcapillary product. The product includes matrix layers of thermoplastic material extrudable into an annular microcapillary product shape. The matrix layers have channels disposed in parallel between the matrix layers of thermoplastic material, and microcapillary material disposable in the channels. In additional aspects, the disclosure relates to a multilayer structure comprising the annular microcapillary product and an article comprising the annular microcapillary product.

### BRIEF DESCRIPTION OF THE DRAWINGS

For the purpose of illustrating the disclosure, there is shown in the drawings a form that is exemplary; it being understood, however, that this disclosure is not limited to the precise arrangements and instrumentalities shown.

FIG. 1 is a perspective view, partially in cross-section, of an extruder with a die assembly for manufacturing a microcapillary film;

FIG. 2A is a longitudinal-sectional view of an inventive microcapillary film;

FIGS. 2B-2C are various cross-sectional views of an inventive microcapillary film;

FIG. 2D is an elevated view of an inventive microcapillary film;

FIG. 2E is a segment 2E of a longitudinal sectional view of the inventive microcapillary film, as shown in FIG. 2B;

FIG. 2F is an exploded view of an inventive microcapillary film;

FIGS. 3A and 3B are schematic perspective views of various configurations of extruder assemblies including an annular die assembly for manufacturing coextruded multi-layer, annular microcapillary products and air-filled multi-layer, annular microcapillary products, respectively;

FIG. 4A is a schematic view of an inventive microcapillary film having microcapillaries with a fluid therein;

FIG. 4B is a cross-sectional view of an inventive coextruded microcapillary film;

FIG. 4C is a cross-sectional view of an inventive air-filled microcapillary film;

FIG. 5 is a schematic view of an inventive annular microcapillary tubing extruded from a die assembly;

FIGS. 6A-6B are perspective views of an inventive annular microcapillary tubing;

FIGS. 7A-7D are partial cross-sectional, longitudinal cross-sectional, end, and detailed cross-sectional views, respectively, of an inventive annular die assembly in an asymmetric flow configuration;

FIGS. 8A-8D are partial cross-sectional, longitudinal cross-sectional, end, and detailed cross-sectional views, respectively, of an inventive annular die assembly in a symmetric flow configuration;

FIGS. 9A-9D are partial cross-sectional, longitudinal cross-sectional, end, and detailed cross-sectional views, respectively, of an inventive annular die assembly in a symmetric flow configuration;

FIG. 10 is a perspective view of an inventive die insert for an annular die assembly; and

FIG. 11 is a flow chart depicting an inventive method of producing an annular microcapillary product.

### DETAILED DESCRIPTION

The description that follows includes exemplary apparatus, methods, techniques, and/or instruction sequences that embody techniques of the present subject matter. However, it is understood that the described embodiments may be practiced without these specific details.

The present disclosure relates to die assemblies and extruders for producing multi-layer, annular microcapillary products. The die assembly includes an annular die insert positioned between manifolds and defining material flow channels therebetween for extruding layers of the thermoplastic material. The die insert has a tip having microcapillary flow channels on an outer surface for insertion of microcapillary material in microcapillaries between the layers. The layers of thermoplastic material with microcapillaries therein may be extruded into multi-layer, annular microcapillary products having various configurations, such as multi-layer, annular microcapillary films (e.g., annular microcapillary blown co-extrusion films or air-filled microcapillary films), tubes or tubing (e.g., annular microcapillary co-extrusion pipes), bottles, molded shapes, blow molding parts, etc. The manifolds and die insert may have ends provided with configurations (e.g., asymmetric and symmetric) to define flow of the thermoplastic material through the channels.

### Multi-Layer Microcapillary Film Extruder

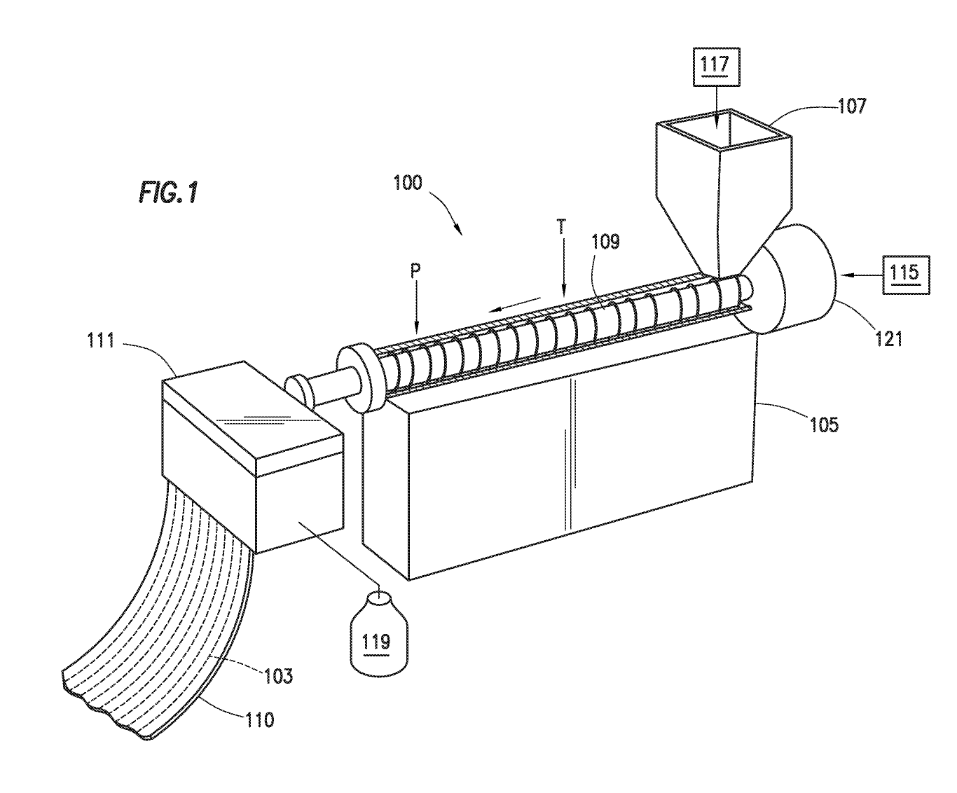

FIG. 1 depicts an example extruder (100) used to form a multi-layer polymeric film (110) with microcapillaries (103). The extruder (100) includes a material housing (105), a material hopper (107), a screw (109), a die assembly (111) and electronics (115). The extruder (100) is shown partially in cross-section to reveal the screw (109) within the material housing (105). While a screw type extruder is depicted, a variety of extruders (e.g., single screw, twin screw, etc.) may be used to perform the extrusion of the material through the extruder (100) and die assembly (111). One or more extruders may be used with one or more die assemblies. Electronics (115) may include, for example, controllers, processors, motors and other equipment used to operate the extruder.

Raw materials, e.g. thermoplastic materials, (117) are placed into the material hopper (107) and passed into the housing (105) for blending. The raw materials (117) are heated and blended by rotation of the screw (109) rotationally positioned in the housing (105) of the extruder (100). Motor (121) may be provided to drive the screw (109) or other driver to advance the material. Heat and pressure are applied as schematically depicted from a heat source H and a pressure source P (e.g., the screw (109)), respectively, to the blended material to force the material through the die assembly (111) as indicated by the arrow. The raw materials are melted and conveyed through the extruder (100) and die assembly (111). The molten thermoplastic material (117) passes through die assembly (111), and is formed into the desired shape and cross section (referred to herein as the ‘profile’). The die assembly (111) may be configured to extrude the molten thermoplastic material (117) into thin sheets of the multi-layer polymeric film (110) as is described further herein.

### Multi-Layer Microcapillary Film

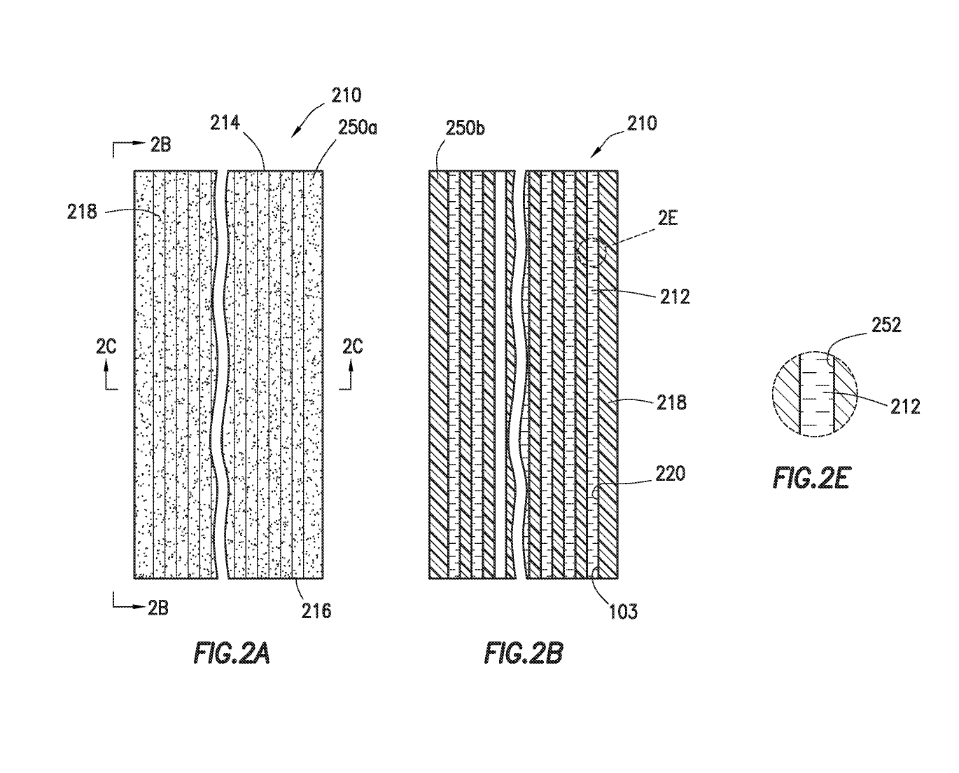

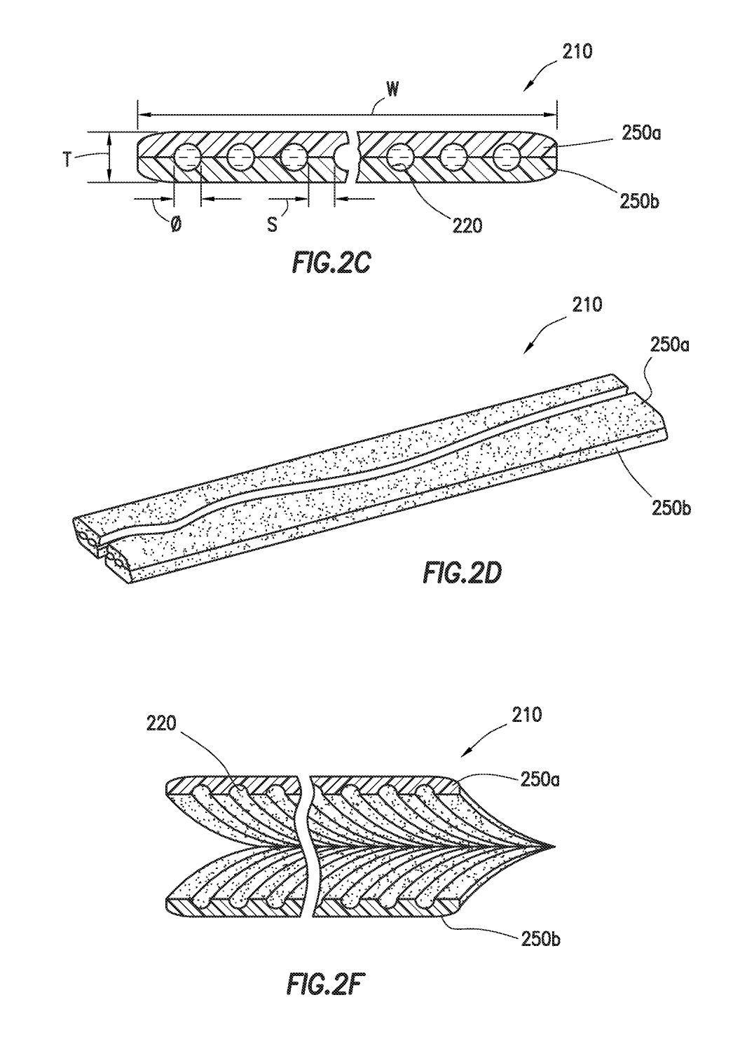

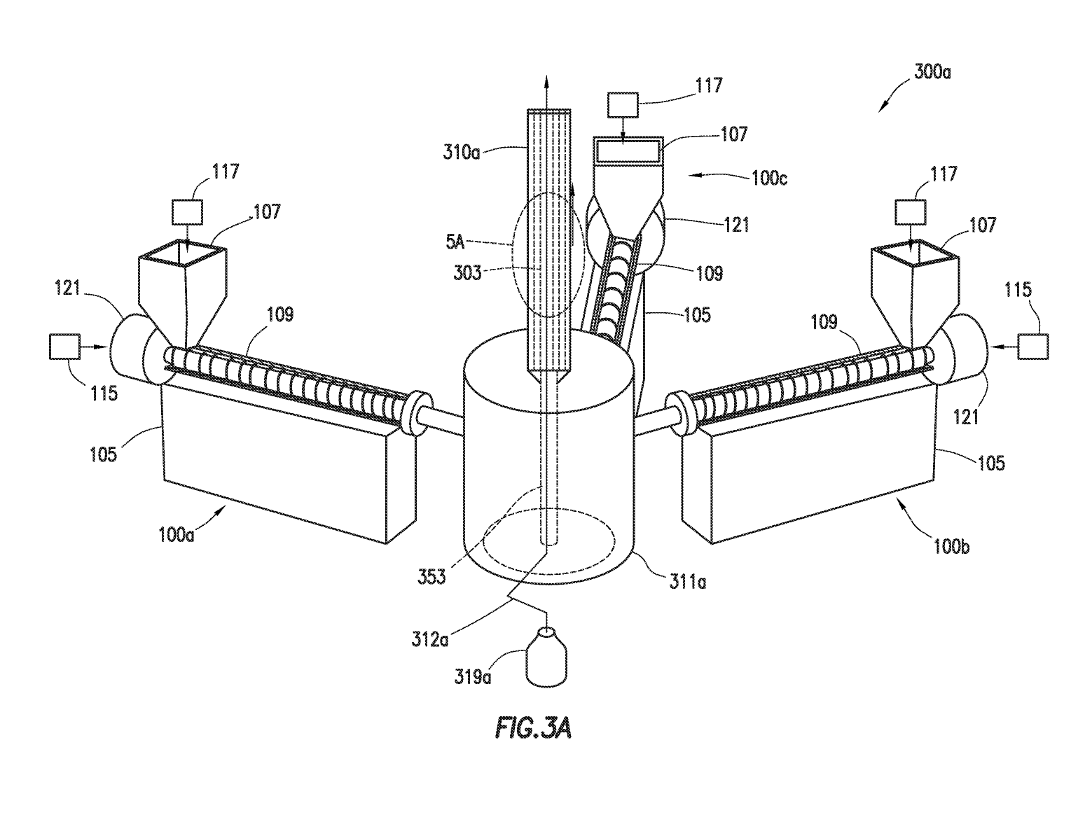

FIGS. 2A-2F depict various views of a multi-layer film (210) which may be produced, for example, by the extruder (100) and die assembly (112) of FIG. 1. As shown in these figures, the multi-layer film (210) is a microcapillary film. The multi-layer film (210) is depicted as being made up of multiple layers (250a,b) of thermoplastic material. The film (210) also has channels (220) positioned between the layers (250a,b).

The multi-layer film (210) may also have an elongate profile as shown in FIG. 2C. This profile is depicted as having a wide width W relative to its thickness T. The width W may be in the range of from about at least 3 inches (7.62 cm) to about 60 inches (152.40 cm) and may be, for example, about 24 inches (60.96 cm) in width, or in the range of from about 20 to about 40 inches (50.80-101.60 cm), or in the range of from about 20 to about 50 inches (50.80-127 cm), etc. The thickness T may be in the range of from about 10 to about 2000 μm (e.g., from about 250 to about 2000 μm). The channels (220) may have a dimension φ (e.g., a width or diameter) in the range of from about 50 to about 500 μm (e.g., from about 100 to about 500 μm), and have a spacing S between the channels (220) in the range of from about 50 to about 500 μm (e.g., from about 100 to about 500 μm). As further described below, the selected dimensions may be proportionally defined. For example, the hole dimension φ may be a diameter of about 30% of the selected thickness T.

As shown, layers (250a,b) are made of a matrix thermoplastic material and channels (220) have a channel fluid (212) therein. The channel fluid may comprise, for example, various materials, such as air, gas, polymers, etc., as will be described further herein. Each layer (250a,b) of the multi-layer film (210) may be made of various polymers, such as those described further herein. Each layer may be made of the same material or of a different material. While only two layers (250a,b) are depicted, the multi-layer film (210) may have any number of layers of material.

Channels (220) may be positioned between one or more sets of layers (250a,b) to define microcapillaries (252) therein. The channel fluid (212) may be provided in the channels (220). Various numbers of channels (220) may be provided as desired. The multiple layers may also have the same or different profiles (or cross-sections). The characteristics, such as shape of the layers (250a,b) and/or channels (220) of the multi-layer film (210), may be defined by the configuration of the die assembly used to extrude the thermoplastic material as will be described more fully herein.

In a given example, the film (210) may include (a) a matrix (218) comprising a matrix thermoplastic material; (b) at least one or more channels (220) are disposed in parallel in the matrix (218) along the microcapillary film or foam (210), wherein the one or more channels (220) are at least about 250 to about 500 μm apart from each other, and wherein each of the one or more channels (220) has a diameter (or width) in the range of at least about 100 to about 500 μm; and (c) a channel fluid (212) disposed in the one or more channels (220), wherein the channel fluid (212) is different than the matrix thermoplastic material (250a,b); and wherein said microcapillary film or foam (210) has a thickness in the range of from about 10 μm to about 2000 μm.

The microcapillary film or foam (210) may have a thickness in the range of from 10 μm to 2000 μm; for example, microcapillary film or foam (210) may have a thickness in the range of from 10 to 2000 μm; or in the alternative, from 100 to 1000 μm; or in the alternative, from 200 to 800 μm; or in the alternative, from 200 to 600 μm; or in the alternative, from 300 to 1000 μm; or in the alternative, from 300 to 900 μm; or in the alternative, from 300 to 700 μm. The film thickness to microcapillary diameter ratio is in the range of from 2:1 to 400:1.

The microcapillary film or foam (210) may comprise at least 10 percent by volume of the matrix (218), based on the total volume of the microcapillary film or foam (210); for example, the microcapillary film or foam (210) may comprise from 10 to 80 percent by volume of the matrix (218), based on the total volume of the microcapillary film or foam (210); or in the alternative, from 20 to 80 percent by volume of the matrix (218), based on the total volume of the microcapillary film or foam (210); or in the alternative, from 30 to 80 percent by volume of the matrix (218), based on the total volume of the microcapillary film or foam (210).

The microcapillary film or foam (210) may comprise from 20 to 90 percent by volume of voidage, based on the total volume of the microcapillary film or foam (210); for example, the microcapillary film or foam (210) may comprise from 20 to 80 percent by volume of voidage, based on the total volume of the microcapillary film or foam (210); or in the alternative, from 20 to 70 percent by volume of voidage, based on the total volume of the microcapillary film or foam (210); or in the alternative, from 30 to 60 percent by volume of voidage, based on the total volume of the microcapillary film or foam (210).

The microcapillary film or foam (210) may comprise from 50 to 100 percent by volume of the channel fluid (212), based on the total voidage volume, described above; for example, the microcapillary film or foam (210) may comprise from 60 to 100 percent by volume of the channel fluid (212), based on the total voidage volume, described above; or in the alternative, from 70 to 100 percent by volume of the channel fluid (212), based on the total voidage volume, described above; or in the alternative, from 80 to 100 percent by volume of the channel fluid (212), based on the total voidage volume, described above.

The inventive microcapillary film or foam (210) has a first end (214) and a second end (216). At least one or more channels (220) are disposed in parallel in the matrix (218) from the first end (214) to the second end (216). The one or more channels (220) may be, for example, at least about 250 μm apart from each other. The one or more channels (220) have a diameter in the range of at least about 250 μm; for example, from 250 μm to 1990 μm; or in the alternative, from 250 to 990 μm; or in the alternative, from 250 to 890 μm; or in the alternative, from 250 to 790 μm; or in the alternative, from 250 to 690 μm or in the alternative, from 250 to 590 μm. The one or more channels (220) may have a cross sectional shape selected from the group consisting of circular, rectangular, oval, star, diamond, triangular, square, the like, and combinations thereof. The one or more channels (220) may further include one or more seals at the first end (214), the second end (216), therebetween the first point (214) and the second end (216), and/or combinations thereof.

The matrix (218) comprises one or more matrix thermoplastic materials (250a,b). Such matrix thermoplastic materials (250a,b) include, but are not limited to, polyolefin, e.g. polyethylene and polypropylene; polyamide, e.g. nylon 6; polyvinylidene chloride; polyvinylidene fluoride; polycarbonate; polystyrene; polyethylene terephthalate; polyurethane and polyester. The matrix (218) may be reinforced via, for example, glass or carbon fibers and/or any other mineral fillers such talc or calcium carbonate. Exemplary fillers include, but are not limited to, natural calcium carbonates, including chalks, calcites and marbles, synthetic carbonates, salts of magnesium and calcium, dolomites, magnesium carbonate, zinc carbonate, lime, magnesia, barium sulphate, barite, calcium sulphate, silica, magnesium silicates, talc, wollastonite, clays and aluminum silicates, kaolins, mica, oxides or hydroxides of metals or alkaline earths, magnesium hydroxide, iron oxides, zinc oxide, glass or carbon fiber or powder, wood fiber or powder or mixtures of these compounds.

Examples of matrix thermoplastic materials (250a,b) include, but are not limited to, homopolymers and copolymers (including elastomers) of one or more alpha-olefins such as ethylene, propylene, 1-butene, 3-methyl-1-butene, 4-methyl-1-pentene, 3-methyl-1-pentene, 1-heptene, 1-hexene, 1-octene, 1-decene, and 1-dodecene, as typically represented by polyethylene, polypropylene, poly-1-butene, poly-3-methyl-1-butene, poly-3-methyl-1-pentene, poly-4-methyl-1-pentene, ethylene-propylene copolymer, ethylene-1-butene copolymer, and propylene-1-butene copolymer; copolymers (including elastomers) of an alpha-olefin with a conjugated or non-conjugated diene, as typically represented by ethylene-butadiene copolymer and ethylene-ethylidene norbornene copolymer; and polyolefins (including elastomers) such as copolymers of two or more alpha-olefins with a conjugated or non-conjugated diene, as typically represented by ethylene-propylene-butadiene copolymer, ethylene-propylene-dicyclopentadiene copolymer, ethylene-propylene-1,5-hexadiene copolymer, and ethylene-propylene-ethylidene norbornene copolymer; ethylene-vinyl compound copolymers such as ethylene-vinyl acetate copolymer, ethylene-vinyl alcohol copolymer, ethylene-vinyl chloride copolymer, ethylene acrylic acid or ethylene-(meth)acrylic acid copolymers, and ethylene-(meth)acrylate copolymer; styrenic copolymers (including elastomers) such as polystyrene, ABS, acrylonitrile-styrene copolymer, α-methylstyrene-styrene copolymer, styrene vinyl alcohol, styrene acrylates such as styrene methylacrylate, styrene butyl acrylate, styrene butyl methacrylate, and styrene butadienes and crosslinked styrene polymers; and styrene block copolymers (including elastomers) such as styrene-butadiene copolymer and hydrate thereof, and styrene-isoprene-styrene triblock copolymer; polyvinyl compounds such as polyvinyl chloride, polyvinylidene chloride, vinyl chloride-vinylidene chloride copolymer, polyvinylidene fluoride, polymethyl acrylate, and polymethyl methacrylate; polyamides such as nylon 6, nylon 6,6, and nylon 12; thermoplastic polyesters such as polyethylene terephthalate and polybutylene terephthalate; polyurethane, polycarbonate, polyphenylene oxide, and the like; and glassy hydrocarbon-based resins, including poly-dicyclopentadiene polymers and related polymers (copolymers, terpolymers); saturated mono-olefins such as vinyl acetate, vinyl propionate, vinyl versatate, and vinyl butyrate and the like; vinyl esters such as esters of monocarboxylic acids, including methyl acrylate, ethyl acrylate, n-butyl acrylate, isobutyl acrylate, 2-ethylhexyl acrylate, dodecyl acrylate, n-octyl acrylate, phenyl acrylate, methyl methacrylate, ethyl methacrylate, and butyl methacrylate and the like; acrylonitrile, methacrylonitrile, acrylamide, mixtures thereof; resins produced by ring opening metathesis and cross metathesis polymerization and the like. These resins may be used either alone or in combinations of two or more.

In selected embodiments, matrix thermoplastic materials (250a,b) may, for example, comprise one or more polyolefins selected from the group consisting of ethylene-alpha olefin copolymers, propylene-alpha olefin copolymers, and olefin block copolymers. In particular, in select embodiments, the matrix thermoplastic materials (250a,b) may comprise one or more non-polar polyolefins.

In specific embodiments, polyolefins such as polypropylene, polyethylene, copolymers thereof, and blends thereof, as well as ethylene-propylene-diene terpolymers, may be used. In some embodiments, exemplary olefinic polymers include homogeneous polymers; high density polyethylene (HDPE); heterogeneously branched linear low density polyethylene (LLDPE); heterogeneously branched ultra low linear density polyethylene (ULDPE); homogeneously branched, linear ethylene/alpha-olefin copolymers; homogeneously branched, substantially linear ethylene/alpha-olefin polymers; and high pressure, free radical polymerized ethylene polymers and copolymers such as low density polyethylene (LDPE) or ethylene vinyl acetate polymers (EVA).

In one embodiment, the ethylene-alpha olefin copolymer may, for example, be ethylene-butene, ethylene-hexene, or ethylene-octene copolymers or interpolymers. In other particular embodiments, the propylene-alpha olefin copolymer may, for example, be a propylene-ethylene or a propylene-ethylene-butene copolymer or interpolymer.

In certain other embodiments, the matrix thermoplastic materials (250a,b) may, for example, be a semi-crystalline polymer and may have a melting point of less than 110° C. In another embodiment, the melting point may be from 25 to 100° C. In another embodiment, the melting point may be between 40 and 85° C.

In one particular embodiment, the matrix thermoplastic materials (250a,b) include a propylene/α-olefin interpolymer composition comprising a propylene/alpha-olefin copolymer, and optionally one or more polymers, e.g. a random copolymer polypropylene (RCP). In one particular embodiment, the propylene/alpha-olefin copolymer is characterized as having substantially isotactic propylene sequences. “Substantially isotactic propylene sequences” means that the sequences have an isotactic triad (mm) measured by 13C NMR of greater than about 0.85; in the alternative, greater than about 0.90; in another alternative, greater than about 0.92; and in another alternative, greater than about 0.93. Isotactic triads are well-known in the art and are described in, for example, U.S. Pat. No. 5,504,172 and International Publication No. WO 00/01745, which refers to the isotactic sequence in terms of a triad unit in the copolymer molecular chain determined by 13C NMR spectra.

The propylene/alpha-olefin copolymer may have a melt flow rate in the range of from 0.1 to 500 g/10 minutes, measured in accordance with ASTM D-1238 (at 230° C./2.16 Kg). All individual values and subranges from 0.1 to 500 g/10 minutes are included herein and disclosed herein; for example, the melt flow rate can be from a lower limit of 0.1 g/10 minutes, 0.2 g/10 minutes, or 0.5 g/10 minutes to an upper limit of 500 g/10 minutes, 200 g/10 minutes, 100 g/10 minutes, or 25 g/10 minutes. For example, the propylene/alpha-olefin copolymer may have a melt flow rate in the range of from 0.1 to 200 g/10 minutes; or in the alternative, the propylene/alpha-olefin copolymer may have a melt flow rate in the range of from 0.2 to 100 g/10 minutes; or in the alternative, the propylene/alpha-olefin copolymer may have a melt flow rate in the range of from 0.2 to 50 g/10 minutes; or in the alternative, the propylene/alpha-olefin copolymer may have a melt flow rate in the range of from 0.5 to 50 g/10 minutes; or in the alternative, the propylene/alpha-olefin copolymer may have a melt flow rate in the range of from 1 to 50 g/10 minutes; or in the alternative, the propylene/alpha-olefin copolymer may have a melt flow rate in the range of from 1 to 40 g/10 minutes; or in the alternative, the propylene/alpha-olefin copolymer may have a melt flow rate in the range of from 1 to 30 g/10 minutes.

The propylene/alpha-olefin copolymer has a crystallinity in the range of from at least 1 percent by weight (a heat of fusion of at least 2 Joules/gram) to 30 percent by weight (a heat of fusion of less than 50 Joules/gram). All individual values and subranges from 1 percent by weight (a heat of fusion of at least 2 Joules/gram) to 30 percent by weight (a heat of fusion of less than 50 Joules/gram) are included herein and disclosed herein; for example, the crystallinity can be from a lower limit of 1 percent by weight (a heat of fusion of at least 2 Joules/gram), 2.5 percent (a heat of fusion of at least 4 Joules/gram), or 3 percent (a heat of fusion of at least 5 Joules/gram) to an upper limit of 30 percent by weight (a heat of fusion of less than 50 Joules/gram), 24 percent by weight (a heat of fusion of less than 40 Joules/gram), 15 percent by weight (a heat of fusion of less than 24.8 Joules/gram) or 7 percent by weight (a heat of fusion of less than 11 Joules/gram). For example, the propylene/alpha-olefin copolymer may have a crystallinity in the range of from at least 1 percent by weight (a heat of fusion of at least 2 Joules/gram) to 24 percent by weight (a heat of fusion of less than 40 Joules/gram); or in the alternative, the propylene/alpha-olefin copolymer may have a crystallinity in the range of from at least 1 percent by weight (a heat of fusion of at least 2 Joules/gram) to 15 percent by weight (a heat of fusion of less than 24.8 Joules/gram); or in the alternative, the propylene/alpha-olefin copolymer may have a crystallinity in the range of from at least 1 percent by weight (a heat of fusion of at least 2 Joules/gram) to 7 percent by weight (a heat of fusion of less than 11 Joules/gram); or in the alternative, the propylene/alpha-olefin copolymer may have a crystallinity in the range of from at least 1 percent by weight (a heat of fusion of at least 2 Joules/gram) to 5 percent by weight (a heat of fusion of less than 8.3 Joules/gram). The crystallinity is measured via DSC method. The propylene/alpha-olefin copolymer comprises units derived from propylene and polymeric units derived from one or more alpha-olefin comonomers. Exemplary comonomers utilized to manufacture the propylene/alpha-olefin copolymer are C2, and C4 to C10 alpha-olefins; for example, C2, C4, C6 and C8 alpha-olefins.

The propylene/alpha-olefin copolymer comprises from 1 to 40 percent by weight of one or more alpha-olefin comonomers. All individual values and subranges from 1 to 40 weight percent are included herein and disclosed herein; for example, the comonomer content can be from a lower limit of 1 weight percent, 3 weight percent, 4 weight percent, 5 weight percent, 7 weight percent, or 9 weight percent to an upper limit of 40 weight percent, 35 weight percent, 30 weight percent, 27 weight percent, 20 weight percent, 15 weight percent, 12 weight percent, or 9 weight percent. For example, the propylene/alpha-olefin copolymer comprises from 1 to 35 percent by weight of one or more alpha-olefin comonomers; or in the alternative, the propylene/alpha-olefin copolymer comprises from 1 to 30 percent by weight of one or more alpha-olefin comonomers; or in the alternative, the propylene/alpha-olefin copolymer comprises from 3 to 27 percent by weight of one or more alpha-olefin comonomers; or in the alternative, the propylene/alpha-olefin copolymer comprises from 3 to 20 percent by weight of one or more alpha-olefin comonomers; or in the alternative, the propylene/alpha-olefin copolymer comprises from 3 to 15 percent by weight of one or more alpha-olefin comonomers.

The propylene/alpha-olefin copolymer has a molecular weight distribution (MWD), defined as weight average molecular weight divided by number average molecular weight (Mw/Mn) of 3.5 or less; in the alternative 3.0 or less; or in another alternative from 1.8 to 3.0.

Such propylene/alpha-olefin copolymers are further described in details in the U.S. Pat. Nos. 6,960,635 and 6,525,157, incorporated herein by reference. Such propylene/alpha-olefin copolymers are commercially available from The Dow Chemical Company, under the tradename VERSIFY™, or from ExxonMobil Chemical Company, under the tradename VISTAMAXX™.

In one embodiment, the propylene/alpha-olefin copolymers are further characterized as comprising (A) between 60 and less than 100, preferably between 80 and 99 and more preferably between 85 and 99, weight percent units derived from propylene, and (B) between greater than zero and 40, preferably between 1 and 20, more preferably between 4 and 16 and even more preferably between 4 and 15, weight percent units derived from at least one of ethylene and/or a C4-10 α-olefin; and containing an average of at least 0.001, preferably an average of at least 0.005 and more preferably an average of at least 0.01, long chain branches/1000 total carbons. The maximum number of long chain branches in the propylene/alpha-olefin copolymer is not critical, but typically it does not exceed 3 long chain branches/1000 total carbons. The term long chain branch, as used herein with regard to propylene/alpha-olefin copolymers, refers to a chain length of at least one (1) carbon more than a short chain branch, and short chain branch, as used herein with regard to propylene/alpha-olefin copolymers, refers to a chain length of two (2) carbons less than the number of carbons in the comonomer. For example, a propylene/1-octene interpolymer has backbones with long chain branches of at least seven (7) carbons in length, but these backbones also have short chain branches of only six (6) carbons in length. Such propylene/alpha-olefin copolymers are further described in details in the U.S. Provisional Patent Application No. 60/988,999 and International Patent Application No. PCT/US08/082599, each of which is incorporated herein by reference.

In certain other embodiments, the matrix thermoplastic material 11, e.g. propylene/alpha-olefin copolymer, may, for example, be a semi-crystalline polymer and may have a melting point of less than 110° C. In preferred embodiments, the melting point may be from 25 to 100° C. In more preferred embodiments, the melting point may be between 40 and 85° C.

In other selected embodiments, olefin block copolymers, e.g., ethylene multi-block copolymer, such as those described in the International Publication No. WO2005/090427 and U.S. Patent Application Publication No. US 2006/0199930, incorporated herein by reference to the extent describing such olefin block copolymers and the test methods for measuring those properties listed below for such polymers, may be used as the matrix thermoplastic materials (250a,b). Such olefin block copolymer may be an ethylene/α-olefin interpolymer:

(a) having a Mw/Mn from about 1.7 to about 3.5, at least one melting point, Tm, in degrees Celsius, and a density, d, in grams/cubic centimeter, wherein the numerical values of Tm and d corresponding to the relationship:

Tm>−2002.9+4538.5(d)−2422.2(d)2; or

(b) having a Mw/Mn from about 1.7 to about 3.5, and being characterized by a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH having the following relationships:

ΔT>−0.1299(ΔH)+62.81 for ΔH greater than zero and up to 130 J/g,

ΔT≧48° C. for ΔH greater than 130 J/g,

wherein the CRYSTAF peak being determined using at least 5 percent of the cumulative polymer, and if less than 5 percent of the polymer having an identifiable CRYSTAF peak, then the CRYSTAF temperature being 30° C.; or

(c) being characterized by an elastic recovery, Re, in percent at 300 percent strain and 1 cycle measured with a compression-molded film of the ethylene/α-olefin interpolymer, and having a density, d, in grams/cubic centimeter, wherein the numerical values of Re and d satisfying the following relationship when ethylene/α-olefin interpolymer being substantially free of a cross-linked phase:

Re>1481-1629(d); or

(d) having a molecular fraction which elutes between 40° C. and 130° C. when fractionated using TREF, characterized in that the fraction having a molar comonomer content of at least 5 percent higher than that of a comparable random ethylene interpolymer fraction eluting between the same temperatures, wherein said comparable random ethylene interpolymer having the same comonomer(s) and having a melt index, density, and molar comonomer content (based on the whole polymer) within 10 percent of that of the ethylene/α-olefin interpolymer; or

(e) having a storage modulus at 25° C., G′ (25° C.), and a storage modulus at 100° C., G′ (100° C.), wherein the ratio of G′ (25° C.) to G′ (100° C.) being in the range of about 1:1 to about 9:1.

Such olefin block copolymer, e.g. ethylene/α-olefin interpolymer may also:

(a) have a molecular fraction which elutes between 40° C. and 130° C. when fractionated using TREF, characterized in that the fraction having a block index of at least 0.5 and up to about 1 and a molecular weight distribution, Mw/Mn, greater than about 1.3; or

(b) have an average block index greater than zero and up to about 1.0 and a molecular weight distribution, Mw/Mn, greater than about 1.3.

In one embodiment, matrix (218) may further comprise a blowing agent thereby facilitating the formation a foam material. In one embodiment, the matrix may be a foam, for example a closed cell foam. In another embodiment, matrix (218) may further comprise one or more fillers thereby facilitating the formation a microporous matrix, for example, via orientation, e.g. biaxial orientation, or cavitation, e.g. uniaxial or biaxial orientation, or leaching, i.e. dissolving the fillers. Such fillers include, but are not limited to, natural calcium carbonates, including chalks, calcites and marbles, synthetic carbonates, salts of magnesium and calcium, dolomites, magnesium carbonate, zinc carbonate, lime, magnesia, barium sulphate, barite, calcium sulphate, silica, magnesium silicates, talc, wollastonite, clays and aluminum silicates, kaolins, mica, oxides or hydroxides of metals or alkaline earths, magnesium hydroxide, iron oxides, zinc oxide, glass or carbon fiber or powder, wood fiber or powder or mixtures of these compounds.

The one or more channel fluids (212) may include a variety of fluids, such as air or other gases and channel thermoplastic material. The channel thermoplastic materials may be, but are not limited to, polyolefin, e.g. polyethylene and polypropylene; polyamide, e.g. nylon 6; polyvinylidene chloride; polyvinylidene fluoride; polycarbonate; polystyrene; polyethylene terephthalate; polyurethane and polyester. The matrix (218) may be reinforced via, for example, via glass or carbon fibers and/or any other mineral fillers such talc or calcium carbonate. Exemplary fillers include, but are not limited to, natural calcium carbonates, including chalks, calcites and marbles, synthetic carbonates, salts of magnesium and calcium, dolomites, magnesium carbonate, zinc carbonate, lime, magnesia, barium sulphate, barite, calcium sulphate, silica, magnesium silicates, talc, wollastonite, clays and aluminum silicates, kaolins, mica, oxides or hydroxides of metals or alkaline earths, magnesium hydroxide, iron oxides, zinc oxide, glass or carbon fiber or powder, wood fiber or powder or mixtures of these compounds.

Examples of channel fluids (212) include, but are not limited to, homopolymers and copolymers (including elastomers) of one or more alpha-olefins such as ethylene, propylene, 1-butene, 3-methyl-1-butene, 4-methyl-1-pentene, 3-methyl-1-pentene, 1-heptene, 1-hexene, 1-octene, 1-decene, and 1-dodecene, as typically represented by polyethylene, polypropylene, poly-1-butene, poly-3-methyl-1-butene, poly-3-methyl-1-pentene, poly-4-methyl-1-pentene, ethylene-propylene copolymer, ethylene-1-butene copolymer, and propylene-1-butene copolymer; copolymers (including elastomers) of an alpha-olefin with a conjugated or non-conjugated diene, as typically represented by ethylene-butadiene copolymer and ethylene-ethylidene norbornene copolymer; and polyolefins (including elastomers) such as copolymers of two or more alpha-olefins with a conjugated or non-conjugated diene, as typically represented by ethylene-propylene-butadiene copolymer, ethylene-propylene-dicyclopentadiene copolymer, ethylene-propylene-1,5-hexadiene copolymer, and ethylene-propylene-ethylidene norbornene copolymer; ethylene-vinyl compound copolymers such as ethylene-vinyl acetate copolymer, ethylene-vinyl alcohol copolymer, ethylene-vinyl chloride copolymer, ethylene acrylic acid or ethylene-(meth)acrylic acid copolymers, and ethylene-(meth)acrylate copolymer; styrenic copolymers (including elastomers) such as polystyrene, ABS, acrylonitrile-styrene copolymer, α-methylstyrene-styrene copolymer, styrene vinyl alcohol, styrene acrylates such as styrene methylacrylate, styrene butyl acrylate, styrene butyl methacrylate, and styrene butadienes and crosslinked styrene polymers; and styrene block copolymers (including elastomers) such as styrene-butadiene copolymer and hydrate thereof, and styrene-isoprene-styrene triblock copolymer; polyvinyl compounds such as polyvinyl chloride, polyvinylidene chloride, vinyl chloride-vinylidene chloride copolymer, polyvinylidene fluoride, polymethyl acrylate, and polymethyl methacrylate; polyamides such as nylon 6, nylon 6,6, and nylon 12; thermoplastic polyesters such as polyethylene terephthalate and polybutylene terephthalate; polyurethane; polycarbonate, polyphenylene oxide, and the like; and glassy hydrocarbon-based resins, including poly-dicyclopentadiene polymers and related polymers (copolymers, terpolymers); saturated mono-olefins such as vinyl acetate, vinyl propionate, vinyl versatate, and vinyl butyrate and the like; vinyl esters such as esters of monocarboxylic acids, including methyl acrylate, ethyl acrylate, n-butyl acrylate, isobutyl acrylate, 2-ethylhexyl acrylate, dodecyl acrylate, n-octyl acrylate, phenyl acrylate, methyl methacrylate, ethyl methacrylate, and butyl methacrylate and the like; acrylonitrile, methacrylonitrile, acrylamide, mixtures thereof; resins produced by ring opening metathesis and cross metathesis polymerization and the like. These resins may be used either alone or in combinations of two or more.

In selected embodiments, the channel fluid (212) may, for example, comprise one or more polyolefins selected from the group consisting of ethylene-alpha olefin copolymers, propylene-alpha olefin copolymers, and olefin block copolymers. In particular, in select embodiments, the channel fluid (212) may comprise one or more non-polar polyolefins.

In specific embodiments, polyolefins such as polypropylene, polyethylene, copolymers thereof, and blends thereof, as well as ethylene-propylene-diene terpolymers, may be used. In some embodiments, exemplary olefinic polymers include homogeneous polymers; high density polyethylene (HDPE); heterogeneously branched linear low density polyethylene (LLDPE); heterogeneously branched ultra low linear density polyethylene (ULDPE); homogeneously branched, linear ethylene/alpha-olefin copolymers; homogeneously branched, substantially linear ethylene/alpha-olefin polymers; and high pressure, free radical polymerized ethylene polymers and copolymers such as low density polyethylene (LDPE) or ethylene vinyl acetate polymers (EVA).

In one embodiment, the ethylene-alpha olefin copolymer may, for example, be ethylene-butene, ethylene-hexene, or ethylene-octene copolymers or interpolymers. In other particular embodiments, the propylene-alpha olefin copolymer may, for example, be a propylene-ethylene or a propylene-ethylene-butene copolymer or interpolymer.

In certain other embodiments, the channel fluid (212) may, for example, be a semi-crystalline polymer and may have a melting point of less than 110° C. In another embodiment, the melting point may be from 25 to 100° C. In another embodiment, the melting point may be between 40 and 85° C.

In one particular embodiment, the channel fluid (212) is a propylene/α-olefin interpolymer composition comprising a propylene/alpha-olefin copolymer, and optionally one or more polymers, e.g. a random copolymer polypropylene (RCP). In one particular embodiment, the propylene/alpha-olefin copolymer is characterized as having substantially isotactic propylene sequences. “Substantially isotactic propylene sequences” means that the sequences have an isotactic triad (mm) measured by 13C NMR of greater than about 0.85; in the alternative, greater than about 0.90; in another alternative, greater than about 0.92; and in another alternative, greater than about 0.93. Isotactic triads are well-known in the art and are described in, for example, U.S. Pat. No. 5,504,172 and International Publication No. WO 00/01745, which refer to the isotactic sequence in terms of a triad unit in the copolymer molecular chain determined by 13C NMR spectra.

The propylene/alpha-olefin copolymer may have a melt flow rate in the range of from 0.1 to 500 g/10 minutes, measured in accordance with ASTM D-1238 (at 230° C./2.16 Kg). All individual values and subranges from 0.1 to 500 g/10 minutes are included herein and disclosed herein; for example, the melt flow rate can be from a lower limit of 0.1 g/10 minutes, 0.2 g/10 minutes, or 0.5 g/10 minutes to an upper limit of 500 g/10 minutes, 200 g/10 minutes, 100 g/10 minutes, or 25 g/10 minutes. For example, the propylene/alpha-olefin copolymer may have a melt flow rate in the range of from 0.1 to 200 g/10 minutes; or in the alternative, the propylene/alpha-olefin copolymer may have a melt flow rate in the range of from 0.2 to 100 g/10 minutes; or in the alternative, the propylene/alpha-olefin copolymer may have a melt flow rate in the range of from 0.2 to 50 g/10 minutes; or in the alternative, the propylene/alpha-olefin copolymer may have a melt flow rate in the range of from 0.5 to 50 g/10 minutes; or in the alternative, the propylene/alpha-olefin copolymer may have a melt flow rate in the range of from 1 to 50 g/10 minutes; or in the alternative, the propylene/alpha-olefin copolymer may have a melt flow rate in the range of from 1 to 40 g/10 minutes; or in the alternative, the propylene/alpha-olefin copolymer may have a melt flow rate in the range of from 1 to 30 g/10 minutes.

The propylene/alpha-olefin copolymer has a crystallinity in the range of from at least 1 percent by weight (a heat of fusion of at least 2 Joules/gram) to 30 percent by weight (a heat of fusion of less than 50 Joules/gram). All individual values and subranges from 1 percent by weight (a heat of fusion of at least 2 Joules/gram) to 30 percent by weight (a heat of fusion of less than 50 Joules/gram) are included herein and disclosed herein; for example, the crystallinity can be from a lower limit of 1 percent by weight (a heat of fusion of at least 2 Joules/gram), 2.5 percent (a heat of fusion of at least 4 Joules/gram), or 3 percent (a heat of fusion of at least 5 Joules/gram) to an upper limit of 30 percent by weight (a heat of fusion of less than 50 Joules/gram), 24 percent by weight (a heat of fusion of less than 40 Joules/gram), 15 percent by weight (a heat of fusion of less than 24.8 Joules/gram) or 7 percent by weight (a heat of fusion of less than 11 Joules/gram). For example, the propylene/alpha-olefin copolymer may have a crystallinity in the range of from at least 1 percent by weight (a heat of fusion of at least 2 Joules/gram) to 24 percent by weight (a heat of fusion of less than 40 Joules/gram); or in the alternative, the propylene/alpha-olefin copolymer may have a crystallinity in the range of from at least 1 percent by weight (a heat of fusion of at least 2 Joules/gram) to 15 percent by weight (a heat of fusion of less than 24.8 Joules/gram); or in the alternative, the propylene/alpha-olefin copolymer may have a crystallinity in the range of from at least 1 percent by weight (a heat of fusion of at least 2 Joules/gram) to 7 percent by weight (a heat of fusion of less than 11 Joules/gram); or in the alternative, the propylene/alpha-olefin copolymer may have a crystallinity in the range of from at least 1 percent by weight (a heat of fusion of at least 2 Joules/gram) to 5 percent by weight (a heat of fusion of less than 8.3 Joules/gram). The crystallinity is measured via DSC method. The propylene/alpha-olefin copolymer comprises units derived from propylene and polymeric units derived from one or more alpha-olefin comonomers. Exemplary comonomers utilized to manufacture the propylene/alpha-olefin copolymer are C2, and C4 to C10 alpha-olefins; for example, C2, C4, C6 and C8 alpha-olefins.

The propylene/alpha-olefin copolymer comprises from 1 to 40 percent by weight of one or more alpha-olefin comonomers. All individual values and subranges from 1 to 40 weight percent are included herein and disclosed herein; for example, the comonomer content can be from a lower limit of 1 weight percent, 3 weight percent, 4 weight percent, 5 weight percent, 7 weight percent, or 9 weight percent to an upper limit of 40 weight percent, 35 weight percent, 30 weight percent, 27 weight percent, 20 weight percent, 15 weight percent, 12 weight percent, or 9 weight percent. For example, the propylene/alpha-olefin copolymer comprises from 1 to 35 percent by weight of one or more alpha-olefin comonomers; or in the alternative, the propylene/alpha-olefin copolymer comprises from 1 to 30 percent by weight of one or more alpha-olefin comonomers; or in the alternative, the propylene/alpha-olefin copolymer comprises from 3 to 27 percent by weight of one or more alpha-olefin comonomers; or in the alternative, the propylene/alpha-olefin copolymer comprises from 3 to 20 percent by weight of one or more alpha-olefin comonomers; or in the alternative, the propylene/alpha-olefin copolymer comprises from 3 to 15 percent by weight of one or more alpha-olefin comonomers.

The propylene/alpha-olefin copolymer has a molecular weight distribution (MWD), defined as weight average molecular weight divided by number average molecular weight (Mw/Mn) of 3.5 or less; in the alternative 3.0 or less; or in another alternative from 1.8 to 3.0.

Such propylene/alpha-olefin copolymers are further described in details in the U.S. Pat. Nos. 6,960,635 and 6,525,157, incorporated herein by reference. Such propylene/alpha-olefin copolymers are commercially available from The Dow Chemical Company, under the tradename VERSIFY™, or from ExxonMobil Chemical Company, under the tradename VISTAMAXX™.

In one embodiment, the propylene/alpha-olefin copolymers are further characterized as comprising (A) between 60 and less than 100, preferably between 80 and 99 and more preferably between 85 and 99, weight percent units derived from propylene, and (B) between greater than zero and 40, preferably between 1 and 20, more preferably between 4 and 16 and even more preferably between 4 and 15, weight percent units derived from at least one of ethylene and/or a C4-10 α-olefin; and containing an average of at least 0.001, preferably an average of at least 0.005 and more preferably an average of at least 0.01, long chain branches/1000 total carbons. The maximum number of long chain branches in the propylene/alpha-olefin copolymer is not critical, but typically it does not exceed 3 long chain branches/1000 total carbons. The term long chain branch, as used herein with regard to propylene/alpha-olefin copolymers, refers to a chain length of at least one (1) carbon more than a short chain branch, and short chain branch, as used herein with regard to propylene/alpha-olefin copolymers, refers to a chain length of two (2) carbons less than the number of carbons in the comonomer. For example, a propylene/1-octene interpolymer has backbones with long chain branches of at least seven (7) carbons in length, but these backbones also have short chain branches of only six (6) carbons in length. Such propylene/alpha-olefin copolymers are further described in details in the U.S. Provisional Patent Application No. 60/988,999 and International Patent Application No. PCT/US08/082599, each of which is incorporated herein by reference.

In certain other embodiments, the channel fluid 12, e.g. propylene/alpha-olefin copolymer, may, for example, be a semi-crystalline polymer and may have a melting point of less than 110° C. In preferred embodiments, the melting point may be from 25 to 100° C. In more preferred embodiments, the melting point may be between 40 and 85° C.

In other selected embodiments, olefin block copolymers, e.g., ethylene multi-block copolymer, such as those described in the International Publication No. WO2005/090427 and U.S. Patent Application Publication No. US 2006/0199930, incorporated herein by reference to the extent describing such olefin block copolymers and the test methods for measuring those properties listed below for such polymers, may be used as the channel fluid (212). Such olefin block copolymer may be an ethylene/α-olefin interpolymer:

(a) having a Mw/Mn from about 1.7 to about 3.5, at least one melting point, Tm, in degrees Celsius, and a density, d, in grams/cubic centimeter, wherein the numerical values of Tm and d corresponding to the relationship:

Tm>−2002.9+4538.5(d)−2422.2(d)2; or

(b) having a Mw/Mn from about 1.7 to about 3.5, and being characterized by a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH having the following relationships:

ΔT>−0.1299(ΔH)+62.81 for ΔH greater than zero and up to 130 J/g,

ΔT≧48° C. for ΔH greater than 130 J/g,

wherein the CRYSTAF peak being determined using at least 5 percent of the cumulative polymer, and if less than 5 percent of the polymer having an identifiable CRYSTAF peak, then the CRYSTAF temperature being 30° C.; or

(c) being characterized by an elastic recovery, Re, in percent at 300 percent strain and 1 cycle measured with a compression-molded film of the ethylene/α-olefin interpolymer, and having a density, d, in grams/cubic centimeter, wherein the numerical values of Re and d satisfying the following relationship when ethylene/α-olefin interpolymer being substantially free of a cross-linked phase:

Re>1481-1629(d); or

(d) having a molecular fraction which elutes between 40° C. and 130° C. when fractionated using TREF, characterized in that the fraction having a molar comonomer content of at least 5 percent higher than that of a comparable random ethylene interpolymer fraction eluting between the same temperatures, wherein said comparable random ethylene interpolymer having the same comonomer(s) and having a melt index, density, and molar comonomer content (based on the whole polymer) within 10 percent of that of the ethylene/α-olefin interpolymer; or

(e) having a storage modulus at 25° C., G′ (25° C.), and a storage modulus at 100° C., G′ (100° C.), wherein the ratio of G′ (25° C.) to G′ (100° C.) being in the range of about 1:1 to about 9:1.

Such olefin block copolymer, e.g. ethylene/α-olefin interpolymer may also:

(a) have a molecular fraction which elutes between 40° C. and 130° C. when fractionated using TREF, characterized in that the fraction having a block index of at least 0.5 and up to about 1 and a molecular weight distribution, Mw/Mn, greater than about 1.3; or

(b) have an average block index greater than zero and up to about 1.0 and a molecular weight distribution, Mw/Mn, greater than about 1.3.

In one embodiment, the channel fluid (212) may further comprise a blowing agent thereby facilitating the formation of a foam material. In one embodiment, the channel fluid (212) may be formed into a foam, for example a closed cell foam. In another embodiment, the channel fluid (212) may further comprise one or more fillers. Such fillers include, but are not limited to, natural calcium carbonates, including chalks, calcites and marbles, synthetic carbonates, salts of magnesium and calcium, dolomites, magnesium carbonate, zinc carbonate, lime, magnesia, barium sulphate, barite, calcium sulphate, silica, magnesium silicates, talc, wollastonite, clays and aluminum silicates, kaolins, mica, oxides or hydroxides of metals or alkaline earths, magnesium hydroxide, iron oxides, zinc oxide, glass or carbon fiber or powder, wood fiber or powder or mixtures of these compounds.

The films or foams according to the present disclosure may be used in packaging (e.g. reinforced thermoformed parts for trays, tape wrap, buckets, beakers, boxes); thermoformed boat hulls, building panels, seating devices, automotive body parts, fuselage parts, vehicle interior trim, and the like.

One or more inventive films or foams may form one or more layers in a multilayer structure, for example, a laminated multilayer structure or a coextruded multilayer structure. The films or foams may comprise one or more parallel rows of microcapillaries (channels as shown in FIG. 2B). Channels 20 (microcapillaries) may be disposed anywhere in matrix (218), as shown in FIGS. 2A-F.

### EXAMPLES

Inventive film 1 was prepared according to the following process.

The matrix material comprised linear low density polyethylene (LLDPE), available under the tradename DOWLEX™ 2344 from THE DOW CHEMICAL COMPANY™, having a density of approximately 0.933 g/cm3, according to ASTM-D792 and a melt index (I2) of approximately 0.7 g/10 minutes, according to ISO 1133 at 190° C. and 2.16 kg, formed into microcapillary films via the inventive die having a width of 24 inches (60.96 cm) and 530 nozzles thereby forming a microcapillary film having a target thickness of approximately 2 mm having microcapillaries having a target diameter of about 1 mm, the film has a width in the range of about 20 inches (50.80 cm) and 530 capillaries parallel therein. The channel fluid disposed in microcapillaries was ambient air, approximately 25° C.

Inventive film 2 was prepared according to the following process.

The matrix material comprised of polypropylene homopolymer, available under the tradename Braskem PP H110-02N™ available from BRASKEM AMERICA INC.™, a melt flow rate of approximately 2.0 g/10 min (230 C/2.16 Kg) according to ASTM D1238, formed into microcapillary films via the inventive die having a width of 24 inches (60.96 cm) and 530 nozzles thereby forming a microcapillary film having a target thickness of approximately 2 mm having microcapillaries having a target diameter of about 1 mm, the film has a width in the range of about 20 inches (50.80 cm) and 530 capillaries parallel therein. The channel fluid disposed in microcapillaries was ambient air, approximately 25° C.

The present disclosure may be embodied in other forms without departing from the spirit and the essential attributes thereof, and, accordingly, reference should be made to the appended claims, rather than to the foregoing specification, as indicating the scope of the disclosure.

### Multi-Layer, Annular Microcapillary Film Extruder Assemblies

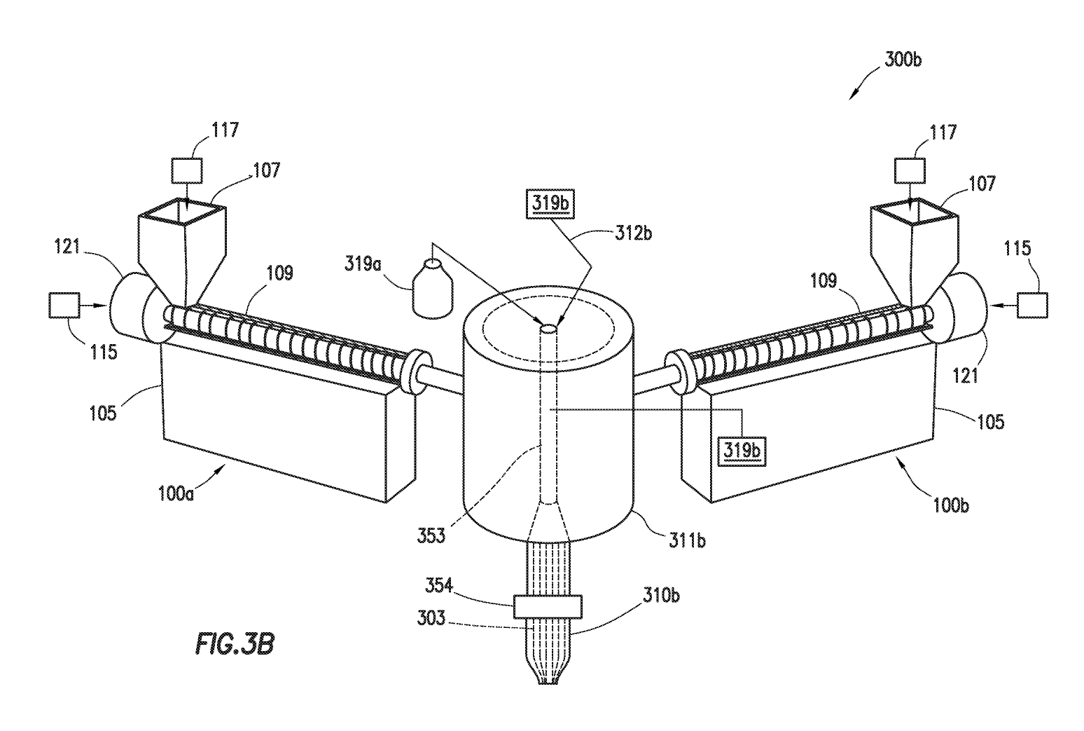

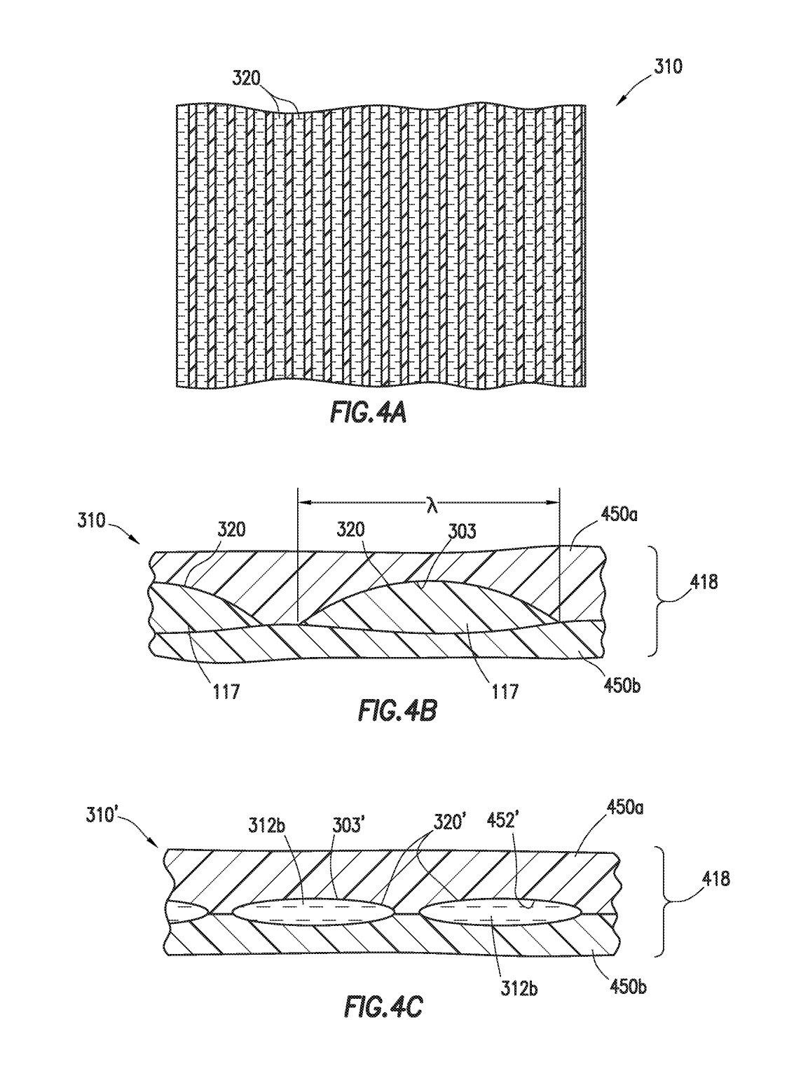

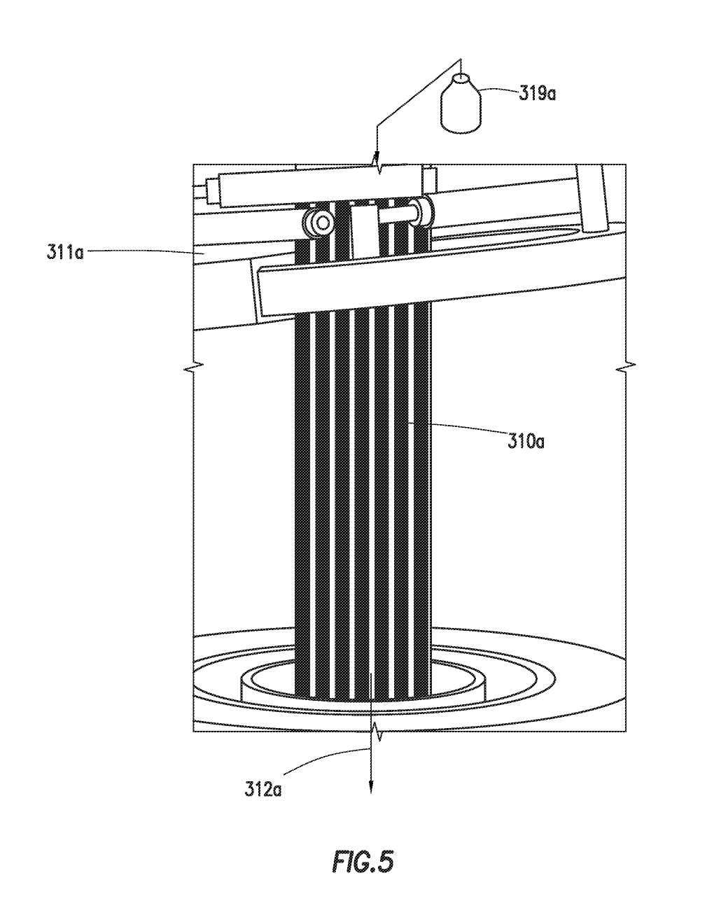

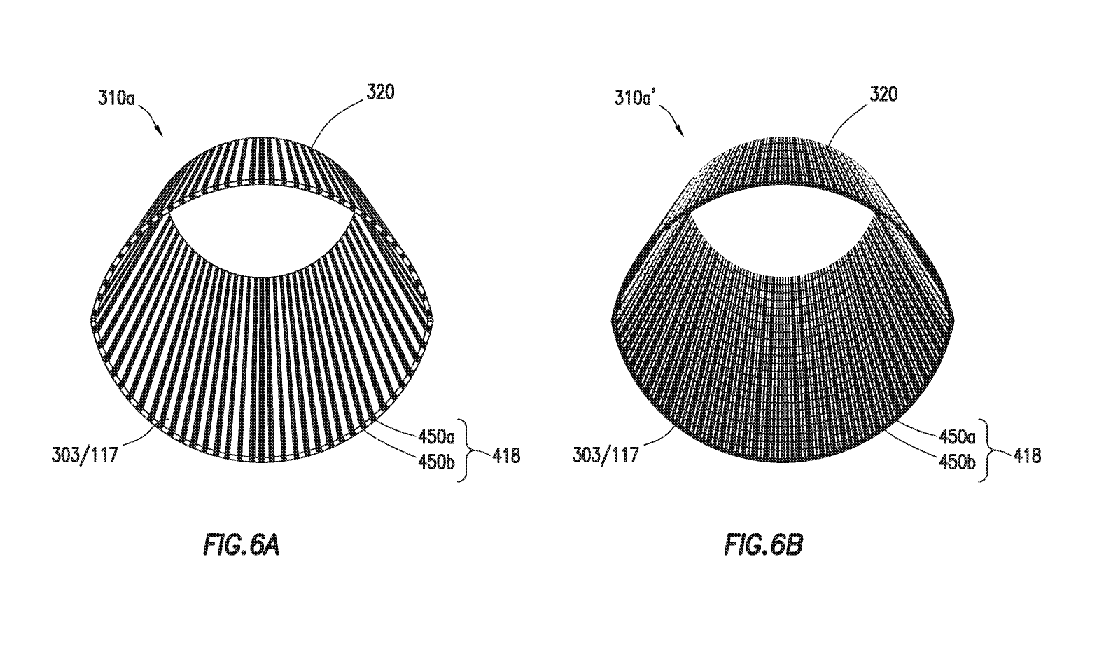

FIGS. 3A and 3B depict example extruder assemblies (300a,b) used to form a multi-layer, annular microcapillary product (310a,b) having microcapillaries (303). The extruder assemblies (300a,b) may be similar to the extruder (100) of FIG. 1 as previously described, except that the extruder assemblies (300a,b) include multiple extruders (100a,b,c), with combined annular microcapillary co-extrusion die assemblies (311a,b) operatively connected thereto. The annular die assemblies (311a,b) have a die insert (353) configured to extrude multi-layer, annular microcapillary products, such as film (310) as shown in FIGS. 4A-4C, tubing (310a) as shown in FIGS. 5, 6A and 6B, and/or molded shapes (310b) as shown in FIG. 3B.

FIG. 3A is in a first configuration of an extruder assembly (300a) with three extruders (100a,b,c) operatively connected to the combined annular microcapillary co-extrusion die assembly (311a). In an example, two of the three extruders may be matrix extruders (100a,b) used to supply thermoplastic material (e.g., polymer) (117) to the die assembly (311a) to form layers of the annular microcapillary product (310a). A third of the extruders may be a microcapillary (or core layer) extruder (100c) to provide a microcapillary material, such as a thermoplastic material (e.g., polymer melt) (117), into the microcapillaries (303) to form a microcapillary phase (or core layer) therein.

The die insert (353) is provided in the die assembly (311a) to combine the thermoplastic material (117) from the extruders (100a,b,c) into the annular microcapillary product (310a). As shown in FIG. 3A, the multi-layer, annular microcapillary product may be a blown tubing (310a) extruded upwardly through the die insert (353) and out the die assembly (311a). Annular fluid (312a) from a fluid source (319a) may be passed through the annular microcapillary product (310a) to shape the multi-layer, annular microcapillary tubing (310a) during extrusion as shown in FIG. 3A, or be provided with a molder (354) configured to produce a multi-layer, annular microcapillary product in the form of an annular microcapillary molding (or molded product), such as a bottle (310b) as shown in FIG. 3B.

FIG. 3B shows a second configuration of an extruder assembly (300b). The extruder assembly (300b) is similar to the extruder assembly (300a), except that the microcapillary extruder (100c) has been replaced with a microcapillary fluid source (319b). The extruders (100a,b) extrude thermoplastic material (as in the example of FIG. 3A). and the microcapillary fluid source (319b) may emit micocapillary material in the form of a microcapillary fluid (312b) through the die insert (353) of the die assembly (311b). The two matrix extruders (100a,b) emit thermoplastic layers, with the microcapillary fluid source (319b) emitting microcapillary fluid (312b) into the microcapillaries (303) therebetween to form the multi-layer, annular microcapillary product (310b). In this version, the annular die assembly (311b) may form film, or blown products as in FIG. 3A, or be provided with the molder (354) configured to produce a multi-layer, annular microcapillary product in the form of an annular microcapillary molding (or molded product), such as a bottle, (310b).

While FIGS. 3A and 3B show each extruder (100a,b,c) as having a separate material housing (105), material hopper (107), screw (109), electronics (115), motor (121), part or all of the extruders (100) may be combined. For example, the extruders (100a,b,c) may each have their own hopper (117), and share certain components, such as electronics (115) and die assembly (311a,b). In some cases, the fluid sources (319a,b) may be the same fluid source providing the same fluid (312a,b), such as air.

The die assemblies (311a,b) may be operatively connected to the extruders (100a,b,c) in a desired orientation, such as a vertical upright position as shown in FIG. 3A, a vertical downward position as shown in FIG. 3B, or a horizontal position as shown in FIG. 1. One or more extruders may be used to provide the matrix material that forms the layers and one or more material sources, such as extruder (100c) and/or microcapillary fluid source (319b), may be used to provide the core layer.

### Multi-Layer, Annular Microcapillary Products

FIGS. 4A-4C depict various views of a multi-layer, annular microcapillary product which may be in the form of a film (310, 310′) produced, for example, by the extruders (300a,b) and die assemblies (311a,b) of FIGS. 3A and/or 3B. As shown in FIGS. 4A and 4B, the multi-layer, annular microcapillary film (310) may be similar to the multi-layer film (210), except that the multi-layer, annular microcapillary film (310) is formed from the annular die assemblies (311a,b) into matrix layers (450a,b) with microcapillaries (303, 303′) therein. The matrix layers (450a,b) collectively form a matrix (418) of the, annular microcapillary film (310). The layers (450a,b) have parallel, linear channels (320) defining microcapillaries (303) therein.

As shown in FIGS. 4B and 4C, the multi-layer, annular microcapillary product (310, 310′) may be extruded with various microcapillary material (117) or microcapillary fluid (312b) therein. The microcapillaries may be formed in channels (320, 320′) with various cross-sectional shapes. In the example of FIG. 4B, the channels (320) have an arcuate cross-section defining the microcapillaries (303) with the microcapillary material (117) therein. The microcapillary material (117) is in the channels (320) between the matrix layers (450a,b) that form the matrix (418). The microcapillary material (117) forms a core layer between the matrix layers (450a,b).

In the example of FIG. 4C, the channels (320′) have another shape, such as an elliptical cross-section defining microcapillaries (303′) with the microcapillary material (312b) therein. The microcapillary material (312b) is depicted as fluid (e.g., air) in the channels (320′) between the layers (450a,b) that form the matrix (418).

The materials used to form the annular microcapillary products as described herein may be selected for a given application. For example, the material may be a plastic, such as a thermoplastic or thermoset material. The thermoplastic material (117) forming the matrix (418) and/or the microcapillary material (117) may be made of the material used to form the film (210) as previously described. For example, the annular microcapillary products may be made of various materials, such as polyolefins, polyethylene, and polypropylene. In the example of FIGS. 4A and 4B, the matrix (418) may be a low density polyethylene (LDPE 501I) and the microcapillary material (117) may be polypropylene (e.g., PP D224). In the example of FIG. 4C, the matrix (418) is made of the low density polyethylene (LDPE 501I) with air as the microcapillary material (312b).

The annular microcapillary products provided herein may be defined for use in various applications, such as agricultural films, packaging bags, stretch film, laminating films, and barrier films. The annular microcapillary products may also be produced, for example, for lightweighting, reinforcing, toughening, and/or other applications. The annular microcapillary products may be provided with structure and/or materials defined to provide desired mechanical properties, such as tensile strength, flexural strength, and/or toughness in multiple directions (e.g., in transverse and machine directions). The annular die assembly (311a,b) may be used to generate various dimensions (e.g., widths and sizes) of the annular microcapillary products. The dimensions may be defined with or without a given amount of trimming and/or scrap material.

The multi-layer, annular microcapillary product (310a) generated by the die assembly (311a) may be extruded from the annular die assembly (311a) into various shapes. As shown in FIGS. 5, 6A and 6B, a multi-layer, annular microcapillary product (310a,310a′) is a tubing (or pipe) extruded from the die assembly (311a). In another example, the multi-layer, annular microcapillary product may be in the shape of a bottle (310b) as shown in FIG. 3B, or other products or shapes.

Referring back to FIG. 5, the fluid source (319a) may pass annular fluid (e.g., air) (312a) through the annular microcapillary product (310a) to support the tubular shape during extrusion. The die assembly (311a) may form the multi-layer, annular microcapillary product (310a,310a′) into a tubular shape as shown in FIGS. 6A-6B.

As also shown by FIGS. 6A and 6B, the thermoplastic materials forming portions of the multi-layer, annular microcapillary product (310a,310a′) may be varied. In the example shown in FIGS. 4A, 4B, and 6A, the layers (450a,b) forming matrix (418) may have a different material from the microcapillary material (117) in the microcapillaries (303) as schematically indicated by the black channels (320) and white matrix (418). In another example, as shown in FIG. 6B, the layers (450a,b) forming a matrix (418) and the material in microcapillaries (303) may be made of the same material, such as low density polyethylene (LDPE 501I), such that the matrix (418) and the channels (320) are both depicted as black.

### Die Assembly

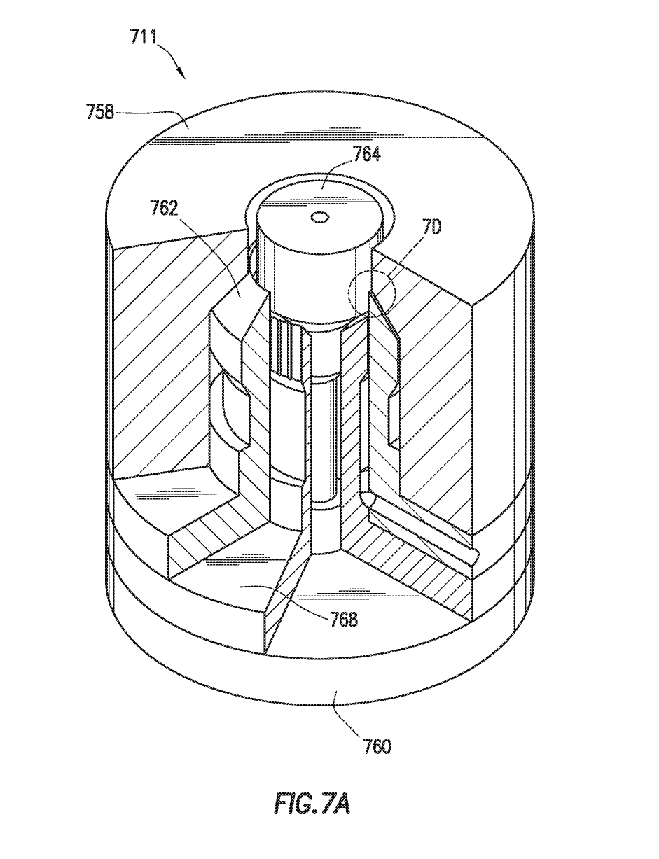

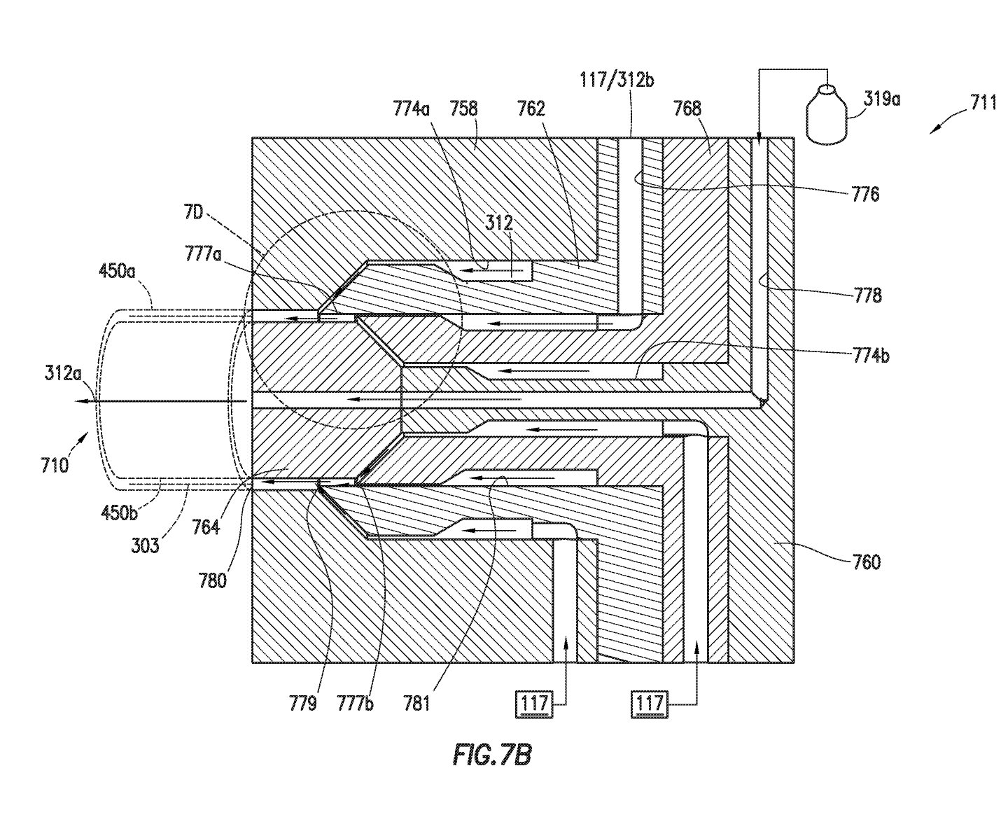

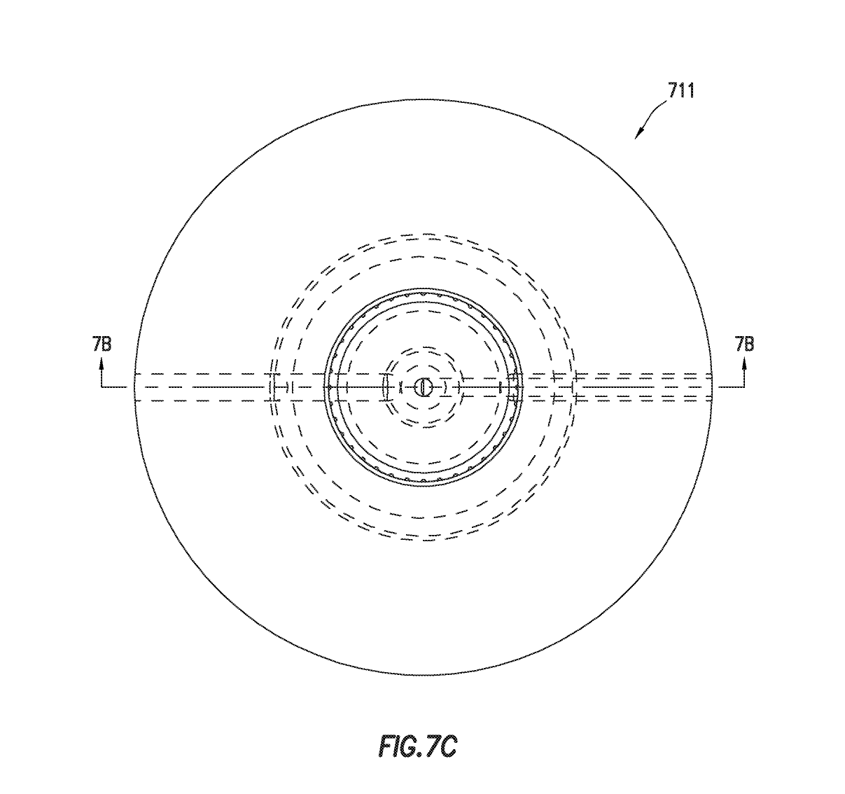

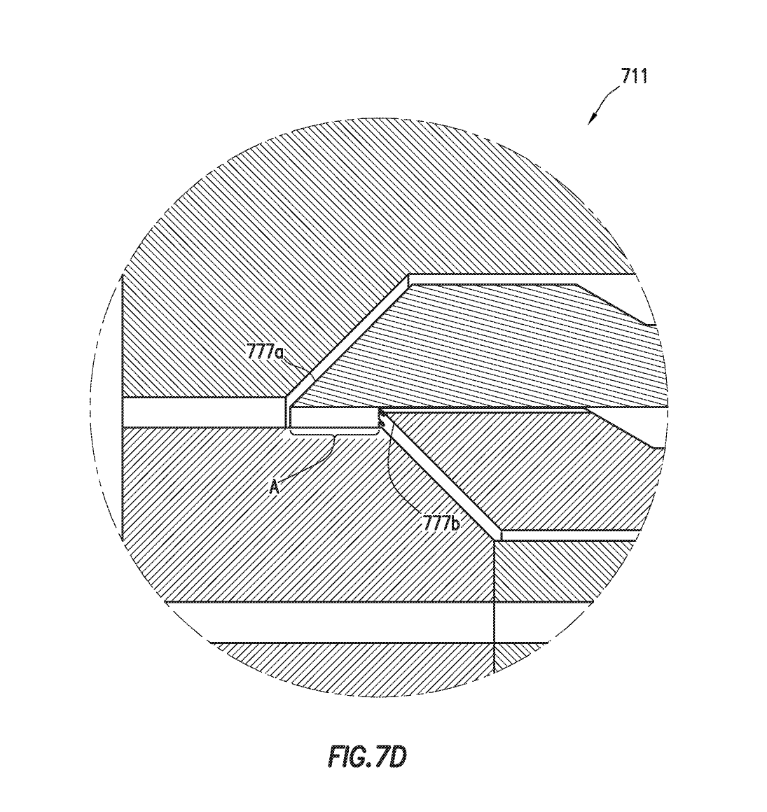

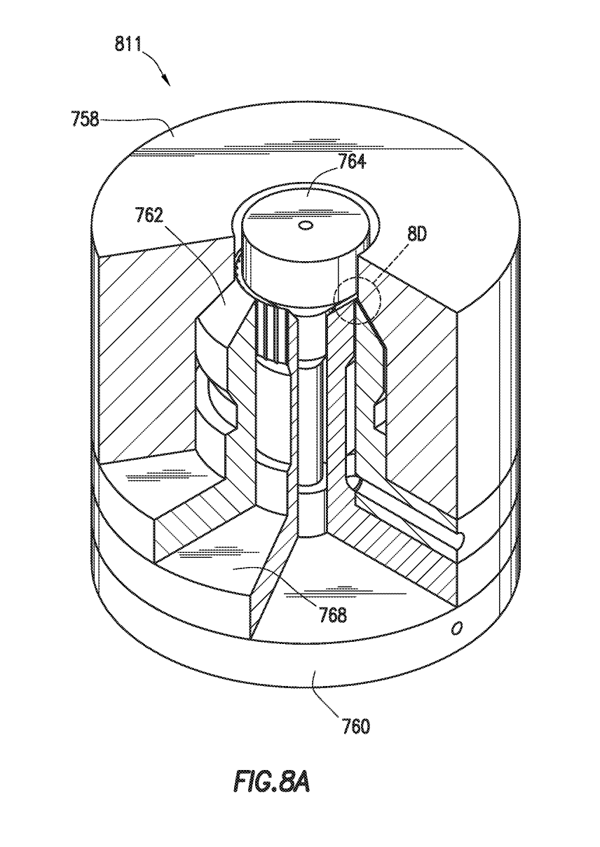

FIGS. 7A-9D depict example configurations of die assemblies (711,811,911) usable as the die assembly (311). While these figures show examples of possible die assembly configurations, combinations and/or variations of the various examples may be used to provide the desired multi-layer, annular microcapillary product, such as those shown in the examples of FIGS. 4A-6B.

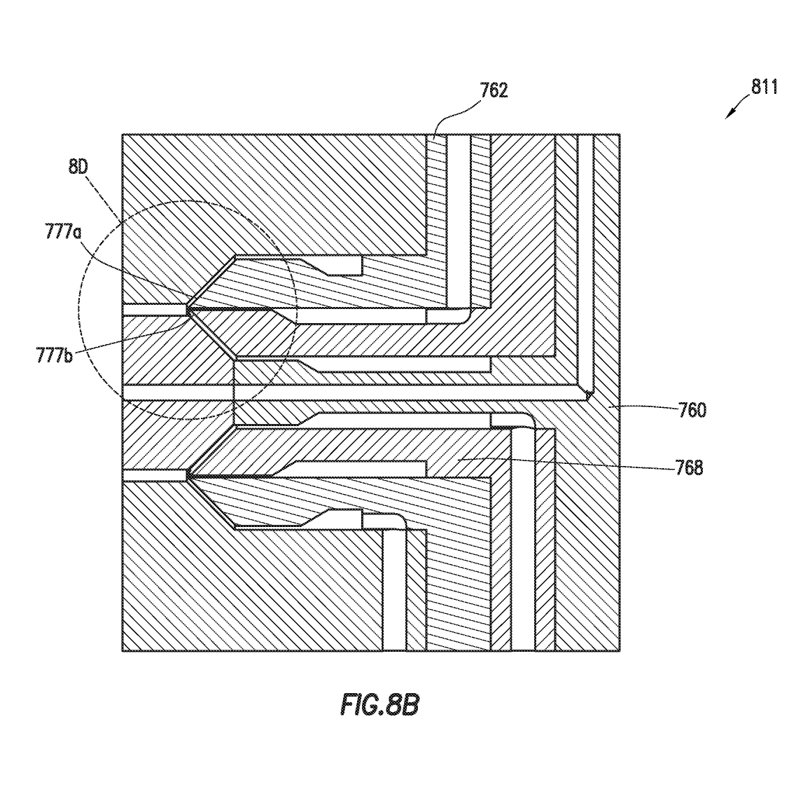

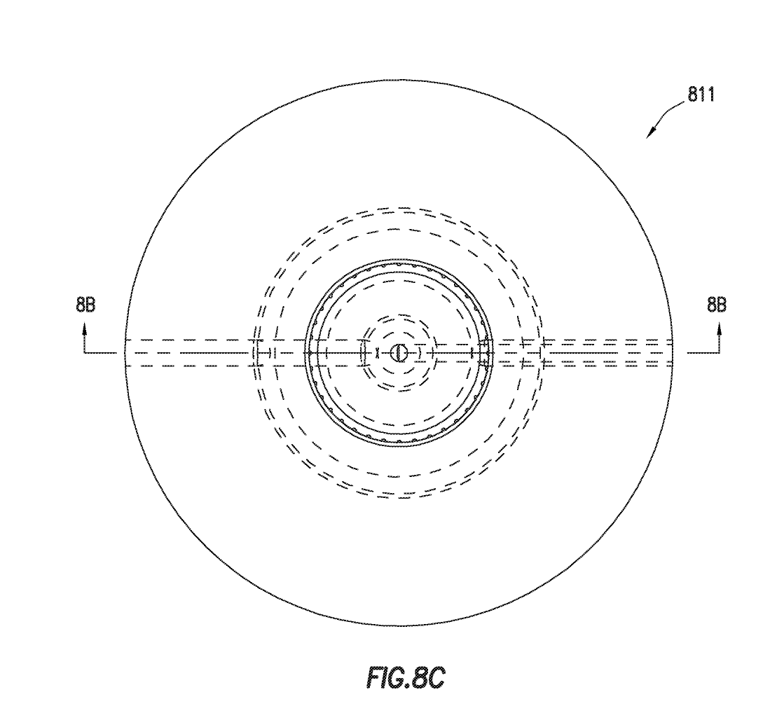

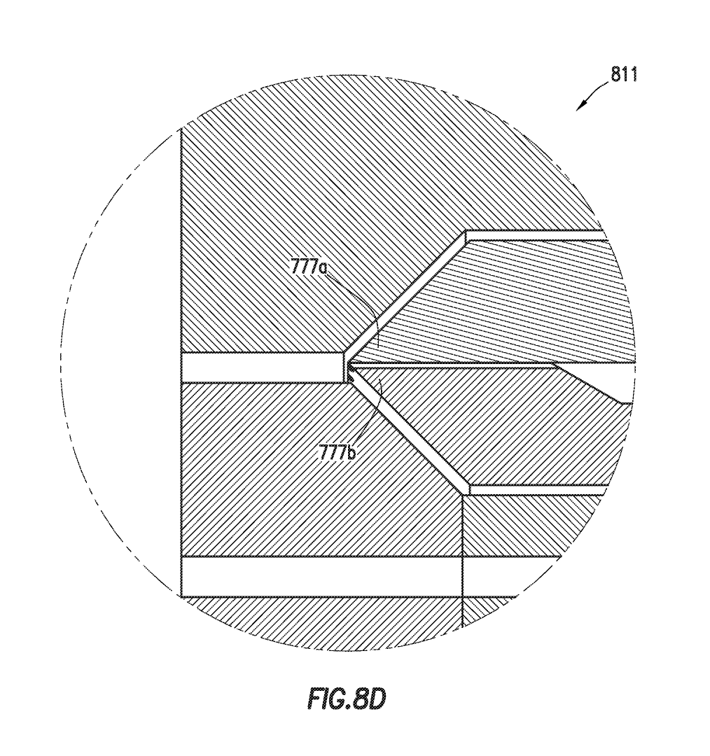

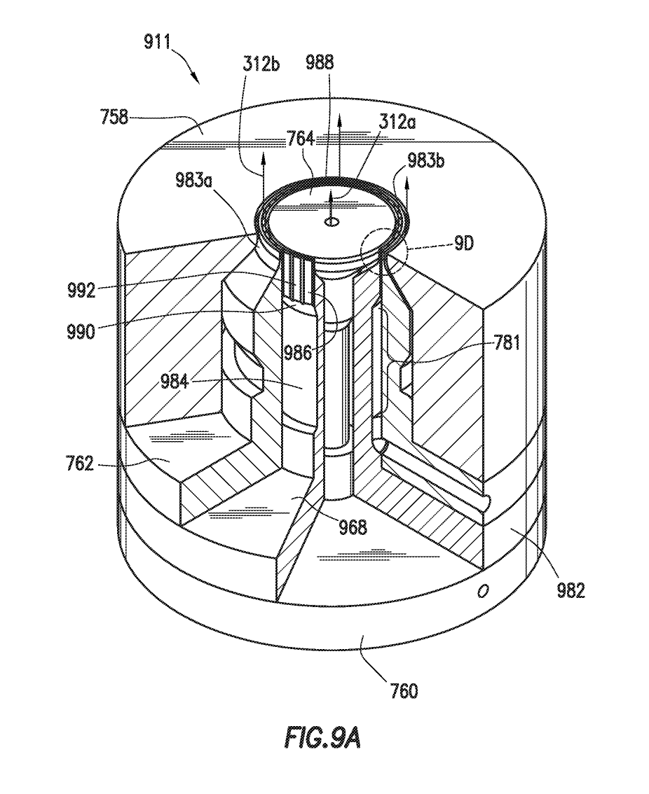

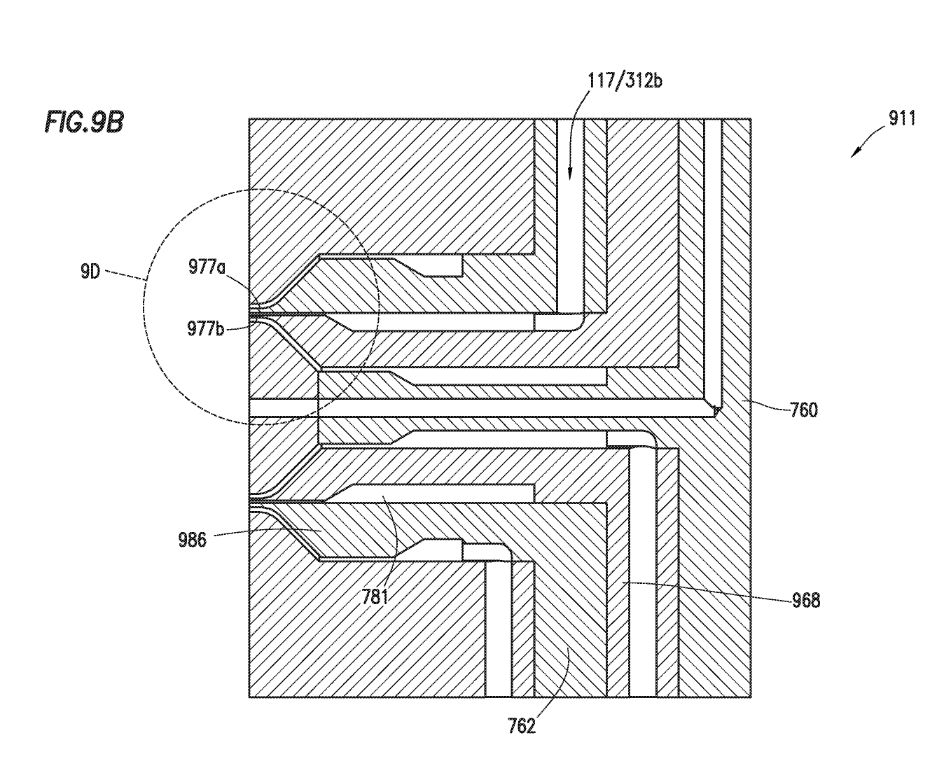

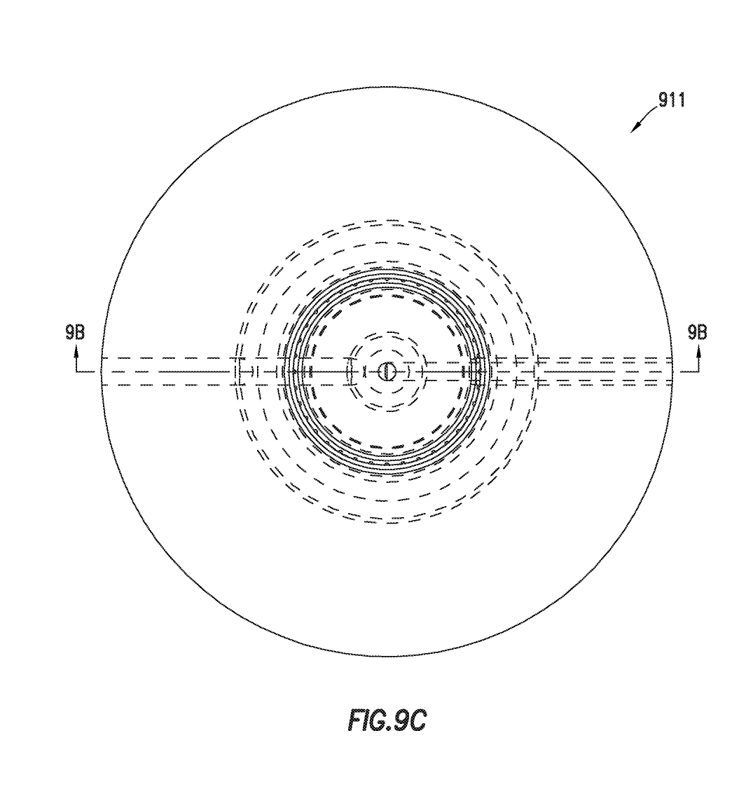

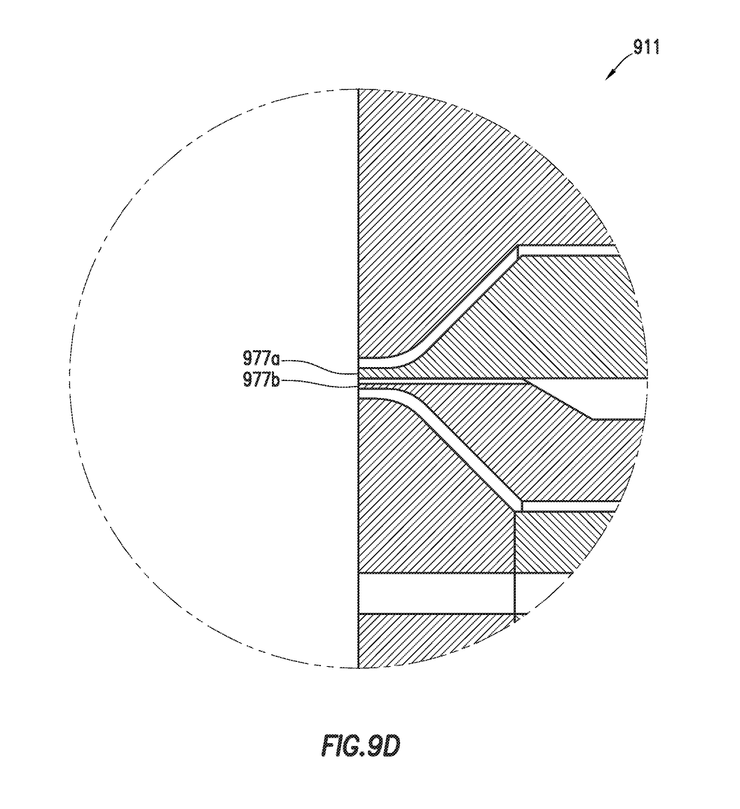

FIGS. 7A-7D depict partial cross-sectional, longitudinal cross-sectional, end, and detailed cross-sectional views, respectively, of the die assembly (711). FIGS. 8A-8D depict partial cross-sectional, longitudinal cross-sectional, end, and detailed cross-sectional views, respectively, of the die assembly (811). FIGS. 9A-9D depict partial cross-sectional, longitudinal cross-sectional, end, and detailed cross-sectional views, respectively, of the die assembly (911). The die assemblies (711, 811) may be used, for example, with the extruder assembly (300a) of FIG. 3A and the die assembly (911) may be used, for example, with the extruder assembly (300b) of FIG. 3B to form multi-layer, annular microcapillary products, such as those described herein.

As shown in FIGS. 7A-7D the die assembly (711) includes a shell (758), an inner manifold (760), an outer manifold (762), a cone (764), and a die insert (768). The shell (758) is a tubular member shaped to receive the outer manifold (762). The outer manifold (762), die insert (768), and the inner manifold (760) are each flange shaped members stacked and concentrically received within the shell (758). While an inner manifold (760) and an outer manifold (762) are depicted, one of more inner and outer manifolds or other devices capable of providing flow channels for forming layers of the matrix may be provided.

The die insert (768) is positioned between the outer manifold (762) and the inner manifold (760). The inner manifold (760) has the cone (764) at an end thereof extending through the die insert (768) and the outer manifold (762) and into the shell (758). The die assembly (711) may be provided with connectors, such as by bolts (not shown) to connect portions of the die assembly (711).

Annular matrix channels (774a,b) are defined between the shell (758) and the outer manifold (762) and between the die insert (768) and the inner manifold (760), respectively. The thermoplastic material (117) is depicted passing through the matrix channels (774a,b) as indicated by the arrows to form the layers (450a,b) of the multi-layer, annular microcapillary product (710). The multi-layer, annular microcapillary product (710) may be any of the multi-layer, annular microcapillary products described herein, such as (310a,b).

A microcapillary channel (776) is also defined between the die insert (768) and the outer manifold (762). The microcapillary channel (776) may be coupled to the microcapillary material source for passing the microcapillary material (117,312b) through the die assembly (711) and between the layers (450a,b) to form the microcapillaries (303) therein. The fluid channel (778) extends through the inner manifold (760) and the cone (764). Annular fluid (312a) from fluid source (319a) flows through the fluid channel (778) and into the product (710a,).

The die insert (768) may be positioned concentrically between the inner manifold (760) and the outer manifold (762) to provide uniform distribution of polymer melt flow through the die assembly (711). The die insert (762) may be provided with a distribution channel (781) along an outer surface thereof to facilitate the flow of the microcapillary material (117/312b) therethrough.

The matrix channels (774a,b) and the microcapillary channel (776) converge at convergence (779) and pass through an extrusion outlet (780) such that thermoplastic material flowing through matrix channels (774a,b) forms layers (450a,b) with microcapillary material (117/312b) from microcapillary channel (776) therebetween. The outer manifold (762) and die insert (768) each terminate at an outer nose (777a) and an insert nose (777b), respectively. As shown in FIG. 7D, the outer nose (777a) extends a distance A further toward the extrusion outlet (780) and/or a distance A further away from the extrusion outlet (780) than the nose (77b).

The die assemblies (811, 911) of FIGS. 8A-9D may be similar to the die assembly (711) of FIGS. 7A-7D, except that a position of noses (777a,b, 977a,b) of the die insert (768, 968) relative to the outer manifold (762) may be varied. The position of the noses may be adjusted to define a flow pattern, such as asymmetric or symmetric therethrough. As shown in FIGS. 7A-7D, the die assembly (711) is in an asymmetric flow configuration with nose (777b) of the die insort (768) positioned a distance A from the nose (777a) of the outer manifold (762). As shown in FIGS. 8A-8D, the die assembly (811) is in the symmetric flow configuration with the noses (777a,b) of the die insert (768) and the outer manifold (762) being flush.

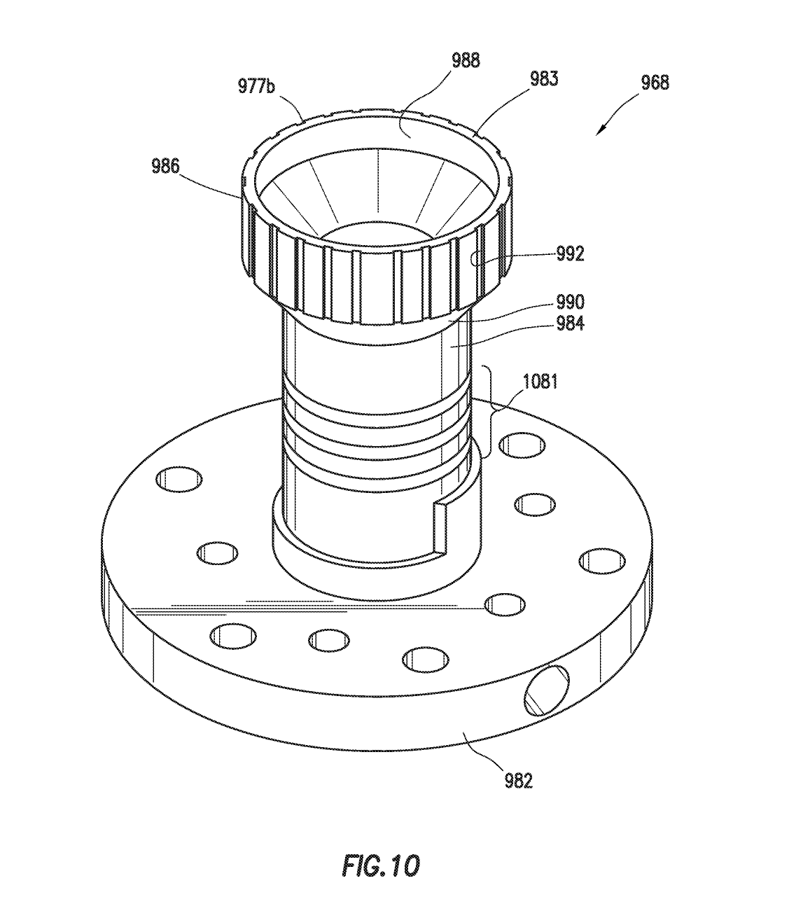

FIGS. 9A-9D and 10 depict an annular die insert (968) provided with features to facilitate the creation of the channels (320), microcapillaries (303), and/or insertion of the microcapillary material (117/312b) therein (see, e.g., FIGS. 4A-4B). The die insert (968) includes a base (982), a tubular manifold (984), and a tip (986). The base (982) is a ring shaped member that forms a flange extending from a support end of the annular microcapillary manifold (984). The base (982) is supportable between the inner manifold (760) and outer manifold (762). The outer manifold (762) has an extended nose (977a) and the die insert (968) has an extended nose (977b) positioned flush to each other to define a symmetric flow configuration through the die assembly (911).

The tip (986) is an annular member at a flow end of the tubular manifold (984). An inner surface of the tip (986) is inclined and shaped to receive an end of the cone (764). The tip (986) has a larger outer diameter than the annular microcapillary manifold (984) with an inclined shoulder (990) defined therebetween. An outer surface of the tip (986) has a plurality of linear, parallel microcapillary flow channels (992) therein for the passage of the microcapillary material (117/312b) therethrough. The outer manifold 762 terminates in a sharp edge (938a) along nose (977a) and tip (968) terminates in a sharp edge (983b) along nose (977b).

The annular microcapillary manifold (984) is an annular member extending between the base (982) and the tip (986). The annular microcapillary manifold (984) is supportable between a tubular portion of the inner manifold (760) and the outer manifold (762). The annular microcapillary manifold (984) has a passage (988) therethrough to receive the inner manifold (760).

The distribution channel (781) may have a variety of configurations. As shown in FIGS. 9A-9D, an outer surface of the annular microcapillary manifold (984) has the distribution channel (781) therealong for the passage of material therethrough. The distribution channel (781) may be in fluid communication with the microcapillary material (117/312b) via the microcapillary channel (776) as schematically depicted in FIG. 9B. The distribution channel (781) may be positioned about the die insert (768) to direct the microcapillary material around a circumference of the die insert (768). The die insert (768) and/or distribution channel (781) may be configured to facilitate a desired amount of flow of microcapillary material (117/312b) through the die assembly. The distribution channel (781) defines a material flow path for the passage of the microcapillary material between the die insert (768) and the outer manifold (762).

A small gap may be formed between the die insert (768) and the outer manifold (762) that allows the microcapillary material (117/312b) to leak out of the distribution channel (781) to distribute the microcapillary material (117/312b) uniformly through the die assembly (311). The distribution channel (781) may be in the form of a cavity or channel extending a desired depth into the die insert (768) and/or the outer manifold (760). For example, as shown in FIGS. 7A-9D, the distribution channel (781) may be a space defined between the outer surface of the die insert (768) and the outer manifold (760). As shown in FIG. 10, the distribution channel is a helical groove (1081) extending a distance along the outer surface of the tubular manifold (984). Part or all of the distribution channel (781, 1081) may be linear, curved, spiral, cross-head, and/or combinations thereof.

### Example 1—Annular Microcapillary Coextrusion Films

As illustrated in FIG. 4A, to distinguish microcapillary material (117, 319b) from the matrix material of matrix (418). Low density polyethylene (LDPE 501I) was used as the matrix (418), while three different materials were employed as the microcapillary materials (117), which included LDPE 501I (melt index: 2 g/10 min@190 degrees C.), LDPE 751A (melt index: 7 g/10 min@190 degrees C.), and polypropylene (PP D224, melt index: 2 g/10 min@230 degrees C.). For LDPE 501I/LDPE 501I and LDPE 501I/LDPE 751A annular microcapillary co-extrusion films, the processing temperature was set to 380 degrees F. To generate LDPE 501I/PP D224 annular microcapillary co-extrusion film, the processing temperature was raised to 410 degree F. due to the higher viscosity of polypropylene.

Referring to the extruder configuration of FIG. 3A, the screw speeds of three extruders (100a,b,c) were set to 50 rpm, giving an extrusion rate of about 1.2 lb/h for each extruder (100a,b,c). The size of microcapillaries (303) in the resulted films may be tuned by controlling the screw speed of one of the extruders (100a,b,c). An experimental protocol for making the annular microcapillary co-extrusion films was given as follows: First, the extruders (100a,b,c) were heated to the processing temperatures with a “soak” time. As the thermoplastic material (polymer pellets) (117) passes through the extruder screw (109) the thermoplastic material (a polymer) (117) was melted to form a polymer melt, which was transported to the die assembly (311a) along the extruder screw (109). The matrix layers (450a,b) were filled with polymer melts provided by two of the extruders (100a,b), while the microcapillaries (303) were filled with the thermoplastic polymer (117) from one of the extruders (100c) to define a core layer between the matrix layers (450a,b).

As shown in FIG. 5, after the layers (450a,b) of polymer melts joined together with the microcapillary material (117) form a core layer therebetween. As these layers exited the die assembly (311a), the annular fluid (312a) from fluid source (319a) was injected into the center of the annular die assembly (311a) to inflate the multi-layer, annular microcapillary tubing (310a). The extruded annular microcapillary product may go through a finishing process involving, for example, cooling, winding, stretching, etc.

FIGS. 4A and 4B show the scanned image and optical microscope image of annular microcapillary product made of LDPE 501I/PP D224 and prepared at a screw speed of 25 rpm for the core layer extruder, respectively. Under this condition, the area of microcapillary (303′) in the cross-section of annular microcapillary product (310) was about 30%, as evidenced by the optical microscope image in FIG. 4B. The film thickness decreased with increasing blow up ratio (BUR), and increased with increasing screw speed of the core layer extruder due to higher extrusion rate. The microcapillary width (λ) held an incremental trend as the BUR and screw speed of the core layer extruder (100c). Similar phenomena may be observed for LDPE 501I/LDPE 501I and LDPE 501I/LDPE 751A annular microcapillary products.

### Example 2—Voided Annular Microcapillary Films

As shown in FIG. 3B, two extruders (100a,b) were used with the die assembly (311b) to generate the multi-layer, annular microcapillary product (310b). The extruders (100a,b) include two 1.5 inch Killion single-screw extruders equipped with a gear pump and an annular microcapillary die assembly (311b). The microcapillary extruder (100c) was replaced by microcapillary material source (or air entrance or air line) (319b) for producing voided annular microcapillary product (310b). The design of the die assembly (311b) is configured to allow each microcapillary (303) to achieve the same air pressure and air flow rate. As shown in FIGS. 9A-9D, the extended noses (977a,b) were placed adjacent an exit of the die assembly (911) to avoid the collapse of microcapillaries during extrusion. The microcapillary fluid (312b) (e.g., plant air) was supplied by the microcapillary material source (319b) with a flow meter. The microcapillary material (312b) was supplied in a wide open manner prior to heating the extruder assembly (300b) to prevent the blockage of the material flow channels (774a,b) and/or microcapillary flow channels (992) by backflow of polymer melt.

The experimental protocol for making microcapillary films was given as follows: Firstly, the extruder (100a,b) and die assembly (311b) were heated to the operating temperatures with a “soak” time. As the thermoplastic material (e.g., polymer pellets) passed through the extruder screw (109) the thermoplastic material was melted to form a melt (e.g., a polymer melt). The extruder screw (109) fed the melt to a gear pump which maintained a substantially constant flow of melt towards the die assembly (311b). Then, the two polymer melt streams of each extruder (100a,b) passed through the die assembly (311b) and over the microcapillary channels (992a,b) and met with streamlines of microccapillary fluid (e.g., air flow) (312b) from the microcapillary material source (319b). As shown in FIG. 4C, the microcapillary material source (319b) maintained the size and shape of microcapillary channels (320′).

As also shown in FIG. 4C, the voided annular microcapillary product (310b) has elliptical microcapillaries (303′) having air as the fluid (312b) therein. The voidage of microcapillaries (303′) in the multi-layer, annular microcapillary product (310b) could be tuned by adjusting the flow rate of the fluid from microcapillary material source (319b), ranging from 0-70%.

### Example 3—Microcapillary Coextrusion Pipes

As shown in FIGS. 6A and 6B, two examples of multi-layer, annular microcapillary products in the form of microcapillary co-extrusion tubings (310a, 310a′) are depicted. The matrix (418) was filled with low density polyethylene (501I) and the microcapillaries (303) were filled with low density polyethylene (501I) or polypropylene (D224). The annular microcapillary die assembly (311a) shaped the polymer melts into a cylinder of slightly greater size than the final pipe product (310a,a′). When the polymer melts exited the die assembly (311a), the annular microcapillary product (310a,a′) was still molten, and possessed high viscosity allowing the multi-layer, annular microcapillary product (311a) to retain the tubular shape of a pipe.

The final dimension of the multi-layer, annular microcapillary tubings (310a) was determined by sizing and cooling operations downstream of the die assembly (311a). The thickness of the multi-layer, annular microcapillary pipe (310a,a′) was about 30 mils. Thicker samples could be achieved by increasing the extrusion rate or defining the dimensions of the die assembly (311a). Microcapillaries (303) could be also filled with microcapillary fluid (312b) (e.g., air) to achieve voided multi-layer, annular microcapillary tubing (310b) usable in even lightweighting applications.

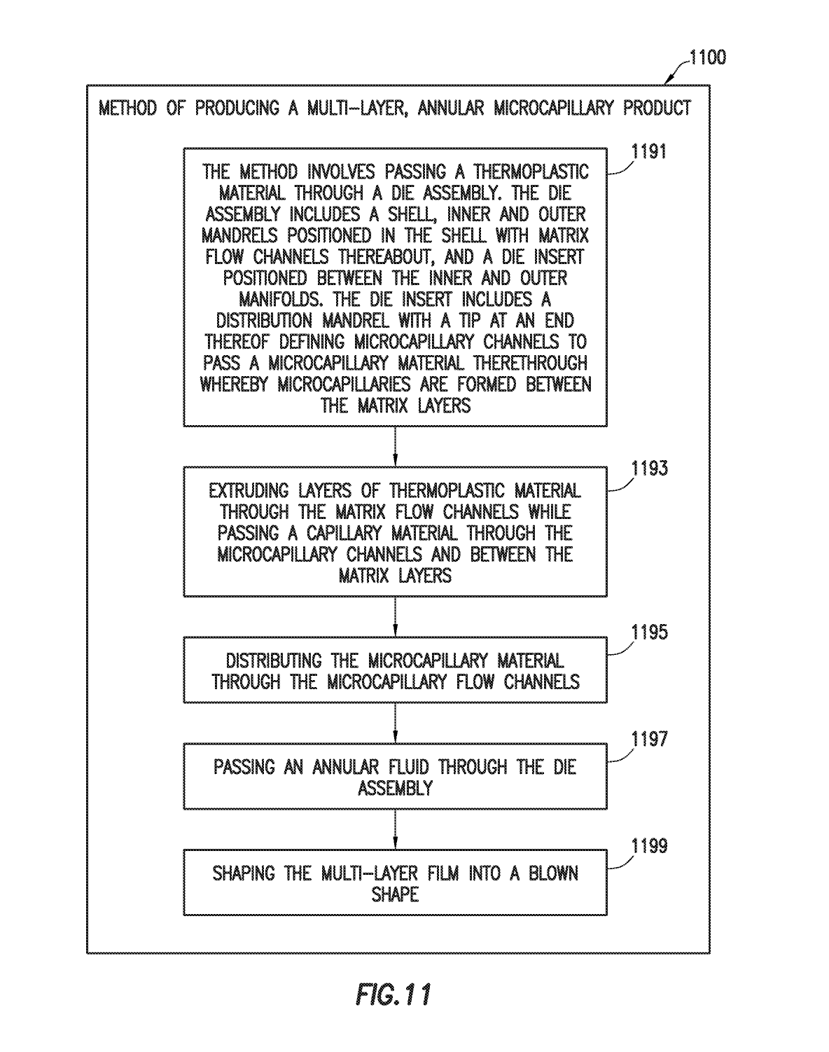

FIG. 11 is a flow chart depicting a method (1100) for producing a multi-layer, annular microcapillary product. The method involves passing (1191) a thermoplastic material through a die assembly. The die assembly includes a shell, inner and outer manifolds positioned in the shell with matrix flow channels thereabout, and a die insert positioned between the inner and outer manifolds. The die insert includes a distribution manifold with a tip at an end thereof defining microcapillary channels to pass a microcapillary material therethrough whereby microcapillaries are formed between the matrix layers manifold. The method may further involve extruding (1193)-layers of the thermoplastic material through the matrix flow channels while passing a capillary material through the microcapillary channels and into the matrix layers, distributing (1195) the thermoplastic material through the microcapillary channels, and passing (1197) an annular fluid through the die assembly.

The method may also involve shaping (1099) the multi-layer film into a multi-layer, annular microcapillary shape, and/or selectively adjusting a profile of the multi-layer film by manipulating one of temperature, flow rate, pressure, material properties and combinations thereof of the thermoplastic material. The multi-layer film may be formed by manipulating flow properties of the thermoplastic material (temperature, flow rate, pressure, etc.) The multi-layer film may be formed by extruding one or more thermoplastic materials through the plurality of film channels.

The method may be performed in any order and repeated as desired. A film may be produced by the method as described.

1. (canceled)

2. (canceled)

3. (canceled)

4. (canceled)

5. (canceled)

6. (canceled)

7. (canceled)

8. (canceled)

9. (canceled)

10. An extruder assembly for producing a multi-layer, annular microcapillary product (110,210,310a, 310a′, 310b, 710), the extruder assembly comprising:
at least one extruder (100,100a,100b,100c,300a,300b), comprising:
a housing (105) having an inlet for receiving a thermoplastic material; and
a driver (109) positionable in the housing to advance the thermoplastic material through the housing;
at least one microcapillary material source (319a,b); and
a die assembly (111,311a,b, 711, 811,911) operatively connectable to an outlet of the housing to receive the thermoplastic material therethrough, the die assembly comprising:
a shell (758);
at least one inner manifold (760) and at least one outer manifold (762) positionable in the shell with matrix flow channels thereabout to receive the thermoplastic material therethrough such that matrix layers (250a,b, 450a,b) of the thermoplastic material are extrudable therefrom; and
a die insert (353, 768, 968) disposable between the at least one inner manifold and the at least one outer manifold, the die insert having a distribution manifold with a tip (986) at an end thereof defining microcapillary channels to pass a microcapillary material therethrough whereby microcapillaries are formed between the matrix layers.

11. (canceled)

12. (canceled)

13. (canceled)

14. The extruder assembly of claim 1, wherein the driver is at least one screw (109) rotationally positionable in the housing.

15. The extruder assembly of claim 1, wherein the at least one extruder is for the matrix layers and wherein the at least one microcapillary material source comprises an additional extruder.

16. The extruder assembly of claim 1, wherein the at least one extruder comprises a separate extruder for forming each of the matrix layers and wherein the at least one microcapillary material source comprises a fluid source (319a,b).

17. (canceled)

18. The extruder assembly of claim 1, wherein the die assembly is one of upright vertical, inverted vertical, and horizontal.

19. (canceled)

20. A method for producing a multi-layer, annular microcapillary product (110,210,310a, 310a′, 310b, 710), comprising:
passing (1191) a thermoplastic material through a die assembly, the die assembly comprising a shell, at least one outer manifold and at least one inner manifold positioned in the shell with matrix flow channels thereabout, and a die insert positioned between the inner and the outer manifolds, the die insert comprising a distribution manifold with a tip at an end thereof and a microcapillary channel; and
extruding (1193) matrix layers of the thermoplastic material through the matrix flow channels while forming microcapillaries in the matrix layers by passing a microcapillary material through the microcapillary channel and between the matrix layers.

21. The method of claim 6, wherein the extruding comprises extruding the matrix layers of thermoplastic material with microcapillaries therein into one of an annular microcapillary film, a tubing, a pipe, and a molded shape.

22. (canceled)

23. (canceled)

24. (canceled)

25. (canceled)

26. (canceled)

27. A multi-layer, annular microcapillary product (110,210,310a, 310a′, 310b, 710), comprising:
matrix layers (250a,b, 450a,b) of thermoplastic material extrudable into an annular microcapillary product shape;
wherein the matrix layers have a plurality of microcapillary channels (220, 320′, 992a,b) disposed in parallel between the matrix layers of thermoplastic material (117), a microcapillary material (212) disposable in the plurality of microcapillary channels.

28. (canceled)

29. (canceled)

30. (canceled)

31. (canceled)

32. The annular microcapillary product of claim 8, wherein the product shape comprises a tubing having a diameter of at least 2 milimeters.

33. The annular microcapillary product of claim 8, wherein product has a thickness in the range of from 1 μm to 25000 μm.

34. The annular microcapillary product of claim 8, wherein the plurality of channels are at least 1 μm apart from each other.

35. The annular microcapillary product of claim 8, wherein a short axis length of the microcapillary channels has a range of 0.5 μm to 20000 μm.

36. The annular microcapillary product of claim 8, wherein at least one of the matrix layers of thermoplastic material is different from at least one other of the matrix layers of thermoplastic material.

37. The annular microcapillary product of claim 8, wherein the thermoplastic material is selected from a group consisting of polyolefin; polyamide; polyvinylidene chloride; polyvinylidene fluoride; polycarbonate; polystyrene; polyethylene vinylalcohol (PVOH), polyvinyl chloride, polylactic acid (PLA) and polyethylene terephthalate.

38. (canceled)

39. An article comprising the annular microcapillary product of claim 8.
